(19) United States
(12) Patent Application Publication
(10) Pub. No.: US 2004/0260209 A1
(43) Pub. Date: Dec. 23, 2004

(54) System and method for face and body treatment

(75) Inventors: Sima Ella, Tel Aviv (IL); Haim Rave, Petach Tikva (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Engli (2001) Ltd.

(21) Appl. No.: 10/600,836

(22) Filed: Jun. 23, 2003

(51) Int. Cl. A61H 15/02; A61H 23/02

(52) U.S. Cl. 601/7; 601/10; 601/15

(57) ABSTRACT

A system and method are provided for self-application of a variety of face and body treatments. Specifically, the system includes a power-and-control console and a light-weight portable device having a plurality of spouts, designed for different portions of the body, and comprising different features. The different features are adapted for different modes of treatment, such as suction, macro-massage treatment, lower-chin firming treatment, breast firming treatment, warming light treatment, infrared light treatment, UV light treatment, LLLT, ultrasound treatment, pulsating magnetic field treatment, constant magnetic field treatment, electrostimulation treatment, cooling-diode treatment, warming-diode treatment, cooling-warming-diode treatment, mechanical epilation, photoepilation, and air blowing. Additionally, each spout includes at least two, and preferably three or more features, for applying different modes of treatment, in tandem or in sequence, in accordance with predetermined schedules. Furthermore, the system may include additional face and body treating devices, such as a face-and-body-cleaning-moisturizing-and-massaging device, hair and nail dryers, and an airbrush. Moreover, the vacuum source of the system may be reversed, for operating as a compressor, in conjunction with the hair and nail dryers and the airbrush. Alternatively, the exhaust of the vacuum source may be used as a compressor. Moreover, the system may further include a compressor to be used in conjunction with the hair and nail dryers, and the airbrush. Additionally, the system may include a sandblasting device for face and body treatment, devices for oxygen, ozone, steam, gentle lymphatic massage, and cupping treatments, and an erection massage device. The system may be provided in male and female versions, as well a in versions for the home and for clinics.

### FIELD OF THE INVENTION

The present invention relates generally to devices for face and body treatments, and in particular, to devices, which employ suction-massage treatment, coupled with at least one additional mode of treatment.

### BACKGROUND OF THE INVENTION

Massage devices, which employ suction, arc known. Generally, they include a structural casing, which defines a vacuum chamber with an open lower surface, and suction means. The casing is adapted for gliding along a portion of the body. Utilizing a partial vacuum, they cause a lifting of the skin, to form a skin fold. As the device is moved across the body, the skin fold is rolled over by the casing. Thus the device imitates and automates a conventional massaging method, known as “palpate and roll”, which stimulates blood circulation.

Inner rollers may be arranged within the casing, so as to press against the skin folds. These may be associated with motorized drives, for a pinching-like effect, or may rotate freely with the movement of the device.

Massage devices, which employ suction, are described for example, in U.S. Pat. No. 6,200,281, to Frajdenrajch, entitled, “Massaging device which is designed to be applied to the skin of a person,” U.S. Pat. No. 6,090,055, it Frajdenrajch, entitled, “Massaging Device,” U.S. Pat. No. 6,017,320 to Bleeker, et al., entitled, “Massaging apparatus having two rollers and a suction chamber,” U.S. Pat. No. 5,897,512 to Zagame, entitled, “Massage appliance for moving over a predetermined zone of the human body,” U.S. Pat. No. 3,841,323 to Dan, entitled “Massage Apparatus,” and U.S. Pat. No. 6,196,982, to Ball, entitled, “Vacuum massager,” whose disclosures are incorporated herein by reference.

Additionally, U.S. Pat. No. 5,961,475, entitled, “Massage apparatus with sucking and mobilising action on skin tissue,” and U.S. Pat. No. 5,885,232, entitled, “Roller massaging apparatus with suction function” both to Guitay, both assigned to LPG Systems of France, and both incorporated herein by reference, describe vaccuum massage systems, generally for spas and h alth centers.

U.S. Pat. No. 4,748,973, to Cho, entitled, “Pneumatic Massage Device,” whose disclosure is incorporated herein by reference, describes a pneumatic massage device, adapted for self-application, without the assistance of another person.

Both U.S. Pat. No. 3,906.940, to Kawada, entitled “Facial Treatment Device,” and U.S. Pat. No. 5,003,966, to Saka, et al., entitled, “Suction device,” whose disclosures are incorporated herein by reference, describe vacuum and massage devices that are adapted for facial treatment.

Another known form of face and body treatment is light treatment, and more specifically, low laser light treatment (LLLT). LLLT refers to laser light at an output of between 1 and 500 Mw. These values are not strong enough to damage chemical bonds in the tissue, but do cause a photochemical effect. LLLT is also referred to as “cold laser” or “soft laser.”

According to “The Healing Nature of light,” http://www.laserpath.com/lpwhatislllt.htm, 1998-2001 LaserPath Therapeutics, downloaded on Apr. 23, 2002, the physiological effects of LLLT include biostimulation, improved metabolism, increase cell metabolism, improved blood circulation and vasodilatation, an analgesic effect, anti-inflammatory and anti-edematous effects, and stimulation of wound healing.

Similarly, according to “Laser Treatment, http://www.skylarkdevice.com/english/laser₁₃ e.htm, 2000-2001 Skylark Inc., and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATP), and increases the synthetic energy of nucleic acid. Additionally, LLLT can stimulate the skin to improve its tension and elasticity, reduce wrinkles, remove scars, and slow down skin aging.

LLLT penetrates the body to a depth of between 3-5 cm, depending on its wavelength. Light waves in the near infrared ranges penetrate the deepest of all light waves in the visible spectrum.

The recommended wavelength for biostimulation is in the range between 630 and 1200 nm.

U.S. Pat. No. 4,930,504 to Diamantopoulos, et al. entitled, “Device for biostimulation of tissue and method for treatment of tissue,” whose disclosure is incorporated herein by reference, describes a system and method for stimulation of skin and it underlying tissue by laser light of various wavelengths, preferably of at least three different wavelengths. The radiation sources are arranged within the array such that radiation of at least two different wavelengths passes directly or indirectly through a single point located within the treated tissue. The radiation sources are preferably laser diodes, superluminous diodes or similar light-emitting diodes that, while low-power radiation sources, can provide significant energy densities to a treatment area. A method of treatment of tissue comprising exposing the treated tissue to the above-described device is also disclosed. The device for biostimulation of tissue may be included within a system with a control panel, a power source, variable pulse frequency, variable pulse duration, a timer for timing the period of treatment, a device for measuring the conductivity of the treated tissue, a device for measuring the optical power emitted by the radiation sources and (or) a device for detecting emissions from the radiation sources. When three different wavelengths are used, the first wavelength is selected from the group consisting of 650 nm, 660 nm, 680 nm, 750 nm, 780 nm, 800 nm, 810 nm and 820 nm; the second wavelength is selected from the group consisting of 830 nm, 840 nm, 850 nm, 860 nm, 870 mm, and 880 nm; and the third wavelength is selected from the group consisting of 900 nm, 904 nm, 950 nm, 1100 nm, 1300 nm and 1500 nm.

U.S. Pat. No. 5,445,146, to Bellinger, entitled, “Biological tissue stimulation by low level optical energy,” whose disclosure is incorporated herein by reference, describes a method of irradiating a biological tissue of a living subject with optical energy. The wavelength and power dissipation level are such as to cause the amount of optical energy absorbed and converted to heat in the tissue to be within a range bounded by a minimum absorption rate sufficient to elevate the average temperature of the irradiated tissue to a level above the basal body temperature, but which is less than the absorption rate at which tissue is converted into a collagenous substance. According to this method, a therapeutic, warming effect is produced within the irradiated tissue, but without causing tissue damage by thermal overheating. The method of using a low level reactive laser system from 100 milliwatts to 800 milliwatts in either a pulsed or continuous mode with optical energy produced by a Nd:YAG laser at a fundamental wavelength of 1064 nanomet rs has been found to reduce pain in soft tissues, reduce inflammation and enhance the healing of tissue by stimulation of microcirculation without subjecting the living tissue to damaging thermal effects. The energy density of the irradiated tissue is limited to the range of from about 1 joule per square centimeter to about 15 joules per square centimeter.

Light treatment at other wavelengths is also known. For example, U.S. Pat. No. 4,558,700, to Mutzhas, entitled, “UV Radiation device for phototreatment of dermatoses, especially psoriasis,” whose disclosure is incorporated herein by reference, describes a UV radiation device for phototreatment of dermatoses, especially psoriasis. The device produces UV radiation at a wavelength range below 300 nm at a first intensity, and radiation at a wavelength range between 300 and 310 nm, at a second intensity, substantially higher than the first intensity. The radiation dose being between 0.7 and 1.0 times the erythema threshold dose. Such a UV radiation device is distinguished by good therapeutic effectiveness and the avoidance of undesirable side effects. The power delivered to the skin using Mutzhas' lamp is described as 150 W/m², which does not have a significant effect on skin temperature.

Similarly, U.S. Pat. No. 4,354,139, to Konijnendijk, et al., entitled, “Low-pressure mercury vapor discharge lamp,” whose disclosure is incorporated herein by reference, describes a low-pressure mercury vapor discharge lamp for radiation purposes. The lamp has a discharge lube made of glass with selective transmission, the tube being coated on the inside with, a luminescent layer. This layer contains a luminescent material, which has the characteristic line emission of gadolinium at 312 nm. The discharge tube is made of glass having an absorption edge located between 260 and 280 nm and the tube has at 312 nm a transmission of at least 80%. It is known that radiation in the wavelength range from 305-320 nm may have a favorable therapeutic effect, for example in the treatment of psoriasis and other skin diseases.

U.S. Pat. No. 5,755,751, to Eckhouse, entitled, “Method and apparatus for therapeutic electromagnetic treatment,” whose disclosure is incorporated herein by reference, describes a therapeutic treatment method includes the steps of providing a pulsed incoherent light output for treatment, directing the pulsed light output to a treatment area, transmitting the pulsed light output through the epidermis at the treatment area, heating the epidermis to a temperature below the temperature at which the epidermis is damaged, and coagulating blood in blood vessels disposed below the epidermis.

According to U.S. Pat. No. 5,755,751, hereinabove, when treating vascular disorder, blood content affects the absorption coefficient of the treatment area. Oxyhemoglobin is the main chromophore, which controls the optical properties of blood and has strong absorption hands in the visible region. More particularly, the strongest absorption peak of oxyhemoglobin occurs at 418 nm and has a band-width of 60 nm. Two additional absorption peaks with lower absorption coefficients occur at 542 and 577 nm. The total band-width of these two peaks is on the order of 100 nm. Additionally, light in the wavelength range of 500 to 600 nm is desirable for the treatment of blood vessel disorders of the skin since it is absorbed by the blood and penetrates through the skin. Longer wavelengths up to 1000 nm are also effective since they can penetrate deeper into the skin, heat the surrounding tissue and, if the pulse-width is long enough, contribute to heating the blood vessel by thermal conductivity. Also, longer wavelengths are effective for treatment of larger diameter vessels because the lower absorption coefficient is compensated for by tile longer path of light in the vessel.

Accordingly, a wide band electromagnetic radiation source that covers the near UV and the visible portion of the spectrum would be desirable for treatment of external skin and vascular disorders. The overall range of wavelengths of the light source should be sufficient to optimize treatment for any of a number of applications. Such a therapeutic electromagnetic radiation device should also be capable of providing an optimal wavelength range within the overall range for the specific disorder being treated. The intensity of the light should be sufficient to cause the desired thermal effect by raising the temperature of the treatment area to the required temperature. When using pulsed light, the pulse-width should be variable over a wide enough range so as to achieve the optimal penetration depth for each application. Therefore, it is desirable to provide a light source having a wide range of wavelengths, which can be selected according to the desired skin treatment, with a controlled power output and a controlled pulse-width for a particular skin application.

Another known form of face and body treatment is ultrasound treatment. According to “Ultrasound Treatment,” Skylark Inc., http://www.skylarkdevice.com/english/ultrasonic_e.htm#head, ultrasound refers to acoustic waves over 20000 Hz, and in general, ultrasound devices for medical and beauty treatment range in frequency from 1 to 5 MHz. A safe standard for a continuous waveform ultrasound is about 1 W/cm², for about 15 minutes, for general muscle treatment. For facial treatment, it is about 0.5 W/cm², for about 10 minutes. A safe standard for a pulse waveform is about 240 mW/cm². By comparison, shattering kidney stones requires about 10 W/cm². The transmission of ultrasound in air is very low, and generally, an interface of a special gel needs to be used between the ultrasound transducer and the skin.

Ultrasound causes a massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitation of the interface material, which leads to a cleansing of the skin. Additionally, ultrasound increases skin absorption of external matter.

Skylark Incorporated (12th FL, 34, Sec. 3, Chuang Shan N. Rd., Taipei, 104, Taiwan Tel: 886-2-25979005 Fax: 886-2-25912344), carries several products for ultrasound treatment. For example, Ultrasound Treatment Unit (1 MHz) SD-957 is a lightweight device that operates at 1 MHz. It is used for treating deep textures, 2-4 cm into the skin, for example, in regions of the leg, the hip, the back, and the like. Ultrasound Beauty SD-958, a beauty/skin care device, operating al 3 MHz, is specifically adapted for facial treatment.

U.S. Pat. No. 6,325,769, to Klopotek, entitled, “Method and apparatus for therapeutic treatment of skin,” whose disclosure is incorporated herein by reference, describes a method and apparatus which use ultrasound for a therapeutic treatment. According to Klopotek, controlled application of ultrasound energy into the dermis layer reduces the extent of wrinkles and rejuvenate the skin. The ultrasound energy triggers a biological response that causes synthesis of new connective tissue in the dermis through activation of fibroblast cells in the dermis without causing or requiring a significant irritation or damage to the epidermis. One purpose of the present method is to provide a cosmetic improvement in the appearance of the skin, meaning that the treated skin surface will have a smoother, rejuvenated appearance, without the need to induce a significant damage to the epidermis layer of the skin.

U.S. Pat. No. 5,665,053 to Jacobs, entitled “Apparatus for performing endermology with ultrasound,” whose disclosure is incorporated herein by reference, describes an endermology body massager having at least two rollers spaced from each other in a parallel configuration. The rollers rotate in the same direction and are mounted on movable axes. A vacuum source is connected to the chamber that houses the rollers. The vacuum source facilitates the suction of the skin between the rollers and helps bring the rollers closer to each other during operation. The rollers or housing have ultrasound generators that are selectively controlled by the operator. In a first embodiment, the ultrasound generators arc located within the rollers. In the second embodiment, the ultrasound generators are disposed in the housing around the rollers. Therefore, a controlled and combined endermology with ultrasound treatment can be achieved.

Another known form of face and body treatment is magnetic treatment According to “Magnetic and electromagnetic treatment,” By David Ramey, www.hcrc.organism/conntriib/ramey/magnet/html, Health Care Reality Check, downloaded on Nov. 20, 2001, researchers believe that a pulsating magnetic field may stimulate biological processes, pertinent for example, to osteogenesis, healing of chronic wounds, and neuronal regeneration.

U.S. Pat. No. 5,669,868, to Markoll, “Treatment of wrinkled discolored or aging skin with magnetic field treatment,” whose disclosure is incorporated herein by reference, describes a process for treating skin by subjecting it to magnetic treatment by an annular coil energized by pulsed D.C. voltage having a rectangular wave form pulsing at the rate of 1-30 CPS, the coil producing a field of under 20 gauss.

Another mode of treatment is epilation, or hair removal. Various manners of epilation are known. For example, the Epilady is a mechanical hair removal device described in http://www.epiladyusa.com, as well as in U.S. Pat. No. 6,277,129, to Poran, entitled “Dual ended hair remover,” whose disclosure is incorporated herein by reference. The Epiladay has a series of high velocity rotating discs, operating like tweezers, that remove hair by the root. Several designs are available, for example, Discrete, and Discrete Plus, both having two speeds, and generally adapted for women's legs, and Lady Bikini, a sensitive trimmer for intimate areas.

Laser based photoepilation is also known. Optical pulses of an appropriate wavelength, pulse duration, and energy density, impinging upon human skin, will result in significant and enduring hair loss. The accepted theory for this phenomenon is that the penetration of the laser into the skin and its subsequent scattering result in heating of the hair shafts and follicles through selective absorption by melanin. The absorption leads to heating of the follicle and subsequent thermal necrosis.

It has been found that for effective photoepilation, the energy must penetrate approximately 3 mm into the tissue. Prevailing thought indicates that this means the absorption should occur in the melanin. Based on the absorption spectrum of melanin, wavelengths in the neighborhood of 700 nm are thought to be efficacious.

U.S. Pat. No. 6,273,885, to Koop, et al., entitled, “Handheld photoepilation device and method,” whose disclosure is incorporated herein by reference, describes a handheld laser tissue treatment device for hair removal. The device comprises a semiconductor diode or diode array laser which emit energy and a device for surface cooling of tissue such that the energy is directed through the cooling device in contact with tissue. The diode laser operates at wavelengths between about 630 nm and 980 nm, and delivers a predetermined amount of energy in a predetermined period of time. Additionally, it has a predetermined spot size. The device utilizes one or more microlenses or microlens arrays to collimate the diode laser energy. Optionally, the device utilizes a deflecting optic For deflecting the diode laser energy through the cooling device which is in contact with tissue in which the deflecting optic is visually transparent such that the operator can see the tissue treatment area. A cooling device such as a sapphire plate or other active or passive cooling means is used to cool the tissue. A method for treatment of tissue, including hair removal, with a handheld device comprises generating laser energy from a semiconductor diode laser, directing the energy through a cooling device in contact with tissue, and treating tissue with the laser energy.

SpaTouch hair removal system, a description of which may be found in http://198.174.40.227/new/radiancy/radiancy, as well as in U.S. Pat. No. 6,214,034, to Azar, entitled, “Method of selective photothermolysis,” and U.S. Pat. No. 6,187,001, to Azar, et al., entitled, “Apparatus and method for removing hair,” whose disclosure are incorporated herein by reference, works on the principle of selective photothermolysis common to other high-tech laser and light-based devices. However, rather than laser, it utilizes pulsed light (in durations of 35 milliseconds) in a wavelength range favorable to melanin, over a very large spot size, for example, about 22×55 mm.

Each of the aforementioned treatment system has specific advantages. A person wishing to benefit from these would have to attend a treatment clinic offering a wide choice of treatment devices, or acquire many different devices, suffering the associated expense and space requirements.

There is thus a need for a device for self-applied face and body treatment, devoid of the above limitations.

### SUMMARY OF THE INVENTION

According to one aspect of the present invention, there is provided a treatment device, comprising:

a spout, which defines an inner chamber, and which is in communication with a vacuum source, for gliding along a portion of a body and applying suction, macro-massage treatment thereto;

at least one feature, integrated with said spout, for applying at least one mode of treatment, different from macro-massage; and

a power source, in power communication with said at least one feature.

According to an additional aspect of the present invention, said vacuum source is a pulsating vacuum source, of varying durations.

According to an alternative aspect of the present invention, said vacuum source is a steady vacuum source.

According to an additional aspect of the present invention, said power source is a power line and said device is detachably connected to said power line.

According to an alternative aspect of the present invention, said power source is a self-contained power source.

According to an additional aspect of the present invention, said self-contained power source is rechargeable.

According to an additional aspect of the present invention, said device is detachably connected to said vacuum source.

According to an additional aspect of the present invention, said vacuum source is a vacuum cleaner.

According to an alternative aspect of the present invention, vacuum source is a dedicated vacuum pump.

According to an additional aspect of the present invention, said device includes a gripping handle.

According to an additional aspect of the present invention, said spout is detachably connected to said gripping handle.

According to an additional aspect of the present invention, said device is adapted for self-application.

According to an additional aspect of the present invention, said device further includes at least one knob, for selectively activating and selectively deactivating said at least one feature, for applying said suction, macro-massage and at least one feature individually and in tandem.

According to an additional aspect of the present invention, said spout further includes at least one roller.

According to an additional aspect of the present invention, said spout further includes at least two rollers.

According to an additional aspect of the present invention, said at least one feature is at least one light source, for applying light treatment to the portion of the body.

According to an additional aspect of the present invention, said at least one light source is operative for photoepilation.

According to an alternative aspect of the present invention, said light treatment is selected from the group consisting of warming light treatment, infrared light treatment, UV light treatment, LLLT, and a combination thereof.

According to an additional aspect of the present invention, said at least one light source comprises a plurality of light sources of a same type.

According to an alternative aspect of the present invention, said at least one light source comprises a plurality of light sources of different types.

According to an additional aspect of the present invention, said at least one light source is adapted for heating the portion of the body.

According to an alternative aspect of the present invention, said at least one light source comprises a mercury vapor discharge lamp.

According to an alternative aspect of the present invention, said at least one light source comprises at least one laser light.

According to an additional aspect of the present invention, said at least one laser light comprises at least two laser lights of a same wavelength.

According to an alternative aspect of the present invention, said at least one laser light comprises at least two laser lights of different wavelengths

According to an additional aspect of the present invention, said at least one laser light is a pulsating laser light.

According to an additional aspect of the present invention, said at least one light source is operative at a wavelength range of 200-350 nm.

According to an alternative aspect of the present invention, said at least one light source is operative at a wavelength range of 350-600 nm.

According to an alternative aspect of the present invention, said at least one light source is operative at a wavelength range of 600-700 nm.

According to an alternative aspect of the present invention, said at least one light source is operative at a wavelength range of 700-900 nm.

According to an alternative aspect of the present invention, said at least one light source is operative at a wavelength range of 900-1100 nm.

According to an alternative aspect of the present invention, said at least one light source is operative at a wavelength range of 1100-1500 nm.

According to an alternative aspect of the present invention, said at least one light source is operative at a wavelength of over 1500 nm.

According to an alternative aspect of the present invention, said at least one feature is at least one an electromagnet, for applying a magnetic field treatment to the position of the body,

According to an additional aspect of the present invention, said magnetic field treatment is selected from the group consisting of pulsating magnetic field treatment and constant magnetic field treatment.

According to an alternative aspect of the present invention, said at least one feature is at least one electrode pair, for applying a electrostimulation treatment to the portion of the body.

According to an alternative aspect of the present invention, said at least one feature is at least one cooling diode.

According to an additional aspect of the present invention, said at least one cooling diode includes at least two cooling diodes.

According to an additional aspect of the present invention, said at least one cooling diode may be flipped so as to operate as a warming diode, for providing warming-diode treatment

According to an alternative aspect of the present invention, said device further includes at least one warming diode, wherein said cooling diode and said warming diode operate in cycles for cooling—warming therapy.

According to an alternative aspect of the present invention, said at least one feature is at least one mechanical epilation device, for applying mechanical epilation to the portion of the body.

According to an alternative aspect of the present invention, said at least one feature is air blowing.

According to an additional aspect of the present invention, said spout includes an additional feature, for applying an additional mode of treatment, selected from the group consisting of warming light treatment, infrared light treatment, UV light treatment, LLLT, ultrasound treatment, pulsating magnetic field treatment, constant magnetic field treatment, electrostimulation treatment, cooling-diode treatment, warming-diode treatment, cooling-warming-diode treatment, photoepilation, mechanical epilation, and air blowing, wherein said treatments may be selectively applied, in tandem and selectively applied in sequence, in accordance with predetermined restrictions.

According to an additional aspect of the present invention, said treatments may be applied in accordance with a predetermined schedule.

According to another aspect of the present invention, there is provided a treatment system, comprising:

a treatment device, comprising:

a spout, which defines an inner chamber, and which is in communication with a vacuum source, for gliding along a portion of a body and applying suction, macro-massage treatment thereto;

at least one feature, integrated with said spout, for applying at least one mode of treatment, different from macro-massage; and

a power source, in power communication with said at least one feature, and

a power-and-control console, comprising:

a vacuum source, in fluid communication with said device, for providing suction;

a system power source, in power communication with said electric pump; and

at least one console control knob, controlling at least said power communication between said pump and said system power source, for activating and deactivating at least said suction.

According to an additional aspect of the present invention, said system power source is in power communication with said device, for providing power to said power source of said device.

According to an additional aspect of the present invention, said at least one mode of treatment is selected from the group consisting of warning light treatment, infrared light treatment, UV light treatment, LLLT, pulsating magnetic field treatment, constant magnetic field treatment, electrostimulation treatment, cooling-diode treatment, warming-diode treatment, cooling-warming-diode treatment, photoepilation, mechanical epilation and air blowing.

According to an additional aspect of the present invention, said spout includes at least two features, for applying at least two modes of treatment, wherein said treatments may be selectively applied in tandem and selectively applied in sequence, in accordance with predetermined restrictions.

According to an additional aspect of the present invention, said treatments may be applied in accordance with a predetermined schedule.

According to an additional aspect of the present invention, said device is detachably connected to said power-and-control console.

According to an additional aspect of the present invention, said system includes a plurality of devices, of different shapes and different modes of treatment.

According to an additional aspect of the present invention, said system includes a plurality of spouts, of different shapes aid different modes of treatment.

According to an additional aspect of the present invention, said device includes at least one roller.

According to an additional aspect of the present invention, said device includes at least two rollers.

According to an additional aspect of the present invention, said system further includes a dedicated device to system further includes a dedicated device to film the lower chin.

According to an additional aspect of the present invention, said system further includes a dedicated device to firm a breast.

According to an additional aspect of the present invention, said system further includes a dedicated device formed as a bra, adapted to firm the two breasts simultaneously.

According to an additional aspect of the present invention, said system further includes a dedicated device to treat impotence.

According to an additional aspect of the present invention, said system includes at least one additional device selected from the group consisting of a hair dryer, a nail dryer, a hair curler, face and body cleaning, moisturizing, and massaging device, and an airbrush, which receive power from said system.

According to an additional aspect of the present invention, said vacuum source may be reversed, so as to operate as a compressor, for providing air flow to a device, selected from the group consisting of a hair dryer, a nail dryer, an airbrush, an oxygen therapy device, an ozone therapy device, a steam therapy device, and a lymphatic massage device.

According to an alternative aspect of die present invention, an exhuast of said vacuum source may operate as an air outlet, for providing air flow to a device, selected from the group consisting of a hair dryer, a nail dryer, an airbrush, an oxygen therapy device, an ozone therapy device, a steam therapy device, a lymphatic massage device, an erection massage device, and a sandblasting device.

According to an additional aspect of the present invention, said system further includes a compressor.

According to an additional aspect of the present invention, said compressor provides air flow to a device, selected from the group consisting of a hair dryer, a nail dryer, an airbrush, an oxygen therapy device, an ozone therapy device, a steam therapy device, a lymphatic massage device, an erection massage device, and a sandblasting device.

According to an additional aspect of the present invention, said system is portable.

According to an additional aspect of the present invention, said system power source includes a battery.

According to an additional aspect of the present invention, said system includes a controller.

According to an additional aspect of the present invention, said system includes a display panel.

According to an additional aspect of the present invention, said display panel is interactive.

According to an additional aspect of the present invention, said system is arranged as a laptop.

According to an additional aspect of the present invention, said system is adapted for self-application.

According to an additional aspect of the present invention, said system further includes a cupping device.

According to still another aspect of the present invention, there is provided a method for face and body treatment comprising:

applying a first mode of treatment, selected from the group consisting of suction, macro-massage treatment, warming light treatment, infrared light treatment, UV light treatment, LLLT, pulsating magnetic field treatment, constant magnetic field treatment, electrostimulation treatment, cooling-diode treatment, warming-diode treatment, cooling-warming-diode treatment, photoepilation, mechanical epilation, and air blowing; and

applying a second mode of treatment, different from said first mode, said second mode of treatment being selected from the group consisting of suction, macro-massage treatment, warming light treatment, infrared light treatment, UV light treatment, LLLT, pulsating magnetic field treatment, constant magnetic field treatment, electrostimulation treatment, cooling-diode treatment, warming-diode treatment, cooling-warming-diode treatment, photoepilation, mechanical epilation, and air blowing,

wherein said first and second modes of treatment may be selectively applied in tandem, and selectively applied in sequence, in accordance with predetermined restrictions.

According to an additional aspect of the present invention, said first and second modes of treatment are applied in accordance with a predetermined schedule. According to an additional aspect of t)he present invention, said modes of treatment are self-applied.

According to an additional aspect of the present invention said method further includes air blowing, to be used in conjunction with a treatment selected from the group consisting of hair drying, nail drying, an airbrush treatment, an oxygen treatment, an ozone treatment, a system treatment, a lymphatic massage treatment, an erection massage treatment and a sandblasting treatment.

The present invention successfully addresses the shortcomings of the presently known configurations by providing a system and method for self-application of a variety of face and body treatments. Specifically, the system includes a power-and-control console and a light-weight portable device having a plurality of spouts, designed for different portions of the body, and comprising different features. The different features are adapted for different modes of treatment, such as suction, macro-massage treatment, lower-chin firming treatment, breast firming treatment, warming light treatment, infrared light treatment, UV light treatment, LLLT, ultrasound treatment, pulsating magnetic field treatment, constant magnetic field treatment, electrostimulation treatment, cooling-diode treatment, warming-diode treatment, cooling-warming-diode treatment, mechanical epilation, photoepilation, and air blowing. Additionally, each spout includes at least two, and preferably three or more features, for applying different modes of treatment, in tandem or in sequence, in accordance with predetermined schedules. Furthermore, the system may include additional face and body treating devices, such as a face-and-body-cleaning-moisturizing-and-massaging device, hair and nail dryers, and an airbrush. Moreover, the vacuum source of the system may be reversed, for operating as a compressor, in conjunction with the hair and nail dryers and the airbrush. Alternatively, the exhaust of the vacuum source may be used as a compressor. Moreover, the system may further include a compressor to be used in conjunction with the hair and nail dryers, and the airbrush. Additionally, the system may include a sandblasting device for face and body treatment, devices for oxygen, ozone, steam, gentle lymphatic massage, and cupping treatments, and an erection massage device. The system may be provided in male and female versions, as well as in versions for the home and for clinics.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1I schematically illustrate a device for face and body treatment, in accordance with a preferred embodiment of the present invention;

FIGS. 2A-2F schematically illustrate spouts for applying suction to the skin, in accordance with preferred embodiments of the present invention;

FIGS. 3A-3C schematically illustrate spouts, comprising at least one light source, for providing light treatment, in accordance with preferred embodiments of the present invention;

FIGS. 4A-4B schematically illustrate spouts, comprising an ultrasound transducer, in accordance with a preferred embodiment of the present invention;

FIGS. 5A-5B schematically illustrate spouts, comprising an electromagnet, in accordance with preferred embodiments of the present invention;

FIGS. 6A-6C schematically illustrate a spout, comprising electrostimulating electrodes, for providing electrostimulation treatment, in accordance with preferred embodiments of the present invention;

FIG. 7 schematically illustrates a spout, comprising cooling diodes, for providing cooling-diode treatment, in accordance with a preferred embodiment of the present invention;

FIG. 8 schematically illustrates a spout, comprising laser diodes and cooling diodes, in accordance with a preferred embodiment or the present invention;

FIGS. 9A and 9C schematically illustrate spouts, designed for light-induced hair removal, in accordance with preferred embodiments of the present invention;

FIGS. 10A-10B schematically illustrate spouts, designed for mechanical hair removal, in accordance with preferred embodiments of the present invention;

FIGS. 11A-11D schematically illustrate a device and a spout, adapted for use with a standard vacuum cleaner;

FIG. 12 schematically illustrates a spout, adapted for treating impotence;

FIGS. 13A-13C schematically illustrate power-and-control consoles, in accordance with preferred embodiments of the present invention;

FIG. 14 schematically illustrates a system for face and body treatment, in accordance with a preferred embodiment of the present invention;

FIG. 15 is arranged as a table, which delineates predetermined restrictions regarding the different features and different modes of treatment, in accordance with the present invention;

FIGS. 16A and 16B arc before and after color photos of a first woman that underwent a treatment, in accordance with the present invention;

FIGS. 17A and 17B are before and after color photos of a second woman that underwent a vacuum treatment, in accordance with the present invention;

FIGS. 18A-18F schematically illustrate a plurality of devices for face, body and hair treatments, which may be included with the system of FIG. 14, in accordance with preferred embodiments of the present invention;

FIGS. 19A-19B schematically illustrate the power-and-control console in accordance with other preferred embodiments of the present invention;

FIGS. 20A-20D schematically illustrate a plurality of devices for face, body and hair treatments, which may be included with the system of FIG. 14, in accordance with other preferred embodiments of the present invention;

FIGS. 21A-21D schematically illustrate the system for face and body treatment, in accordance with another preferred embodiment of the present invention;

FIG. 22 schematically illustrates an oxygen or ozone therapy device, in accordance with a preferred embodiment of the present invention;

FIG. 23 schematically illustrates a steam therapy device, in accordance with a preferred embodiment of the present invention;

FIGS. 24A-24C schematically illustrate a lymphatic massage device, in accordance with a preferred embodiment of the present invention;

FIG. 25 schematically illustrates an erection massage device, in accordance with a preferred embodiment of the present invention;

FIG. 26 schematically illustrates a cupping device, in accordance with a preferred embodiment of the present invention;

FIG. 27 schematically illustrates a face-and-body-treatment system for home use of the woman, in accordance with a preferred embodiment of the present invention;

FIG. 28 schematically illustrates a face-and-body-treatment system for home use of the man, in accordance with a preferred embodiment of the present invention; and

FIG. 29 schematically illustrates a face-and-body-treatment system for clinics, in accordance with a preferred embodiment of the present invention.

### DESCRIPTION OF THE PREFERRED EMBODIMENTS

The present invention is of a system and method for self-application of a variety of face and body treatments. Specifically, the system includes a power-and-control console and a lightweight portable device having a plurality of spouts, designed for different portions of the body, and comprising different features. The different features are adapted for different modes of treatment, such as suction, macro-massage treatment, lower-chin firming treatment, breast firming treatment, warming light treatment, infrared light treatment, UV light treatment, LLLT, ultrasound treatment, pulsating magnetic field treatment, constant magnetic field treatment electrostimulation treatment, cooling-diode treatment, warming-diode treatment. cooling-warming-diode treatment, mechanical epilation, photoepilation, and air blowing. Additionally, each spout includes at least two, and preferably three or more features, for applying different modes of treatment, in tandem or in sequence, in accordance with predetermined schedules. Furthermore, the system may include additional face and body treating devices, such as a face-and-body-cleaning-moisturizing-and-massaging device, hair and nail dryers, and an airbrush. Moreover, the vacuum source of the system may be reversed, for operating as a compressor, in conjunction with the hair and nail dryers and the airbrush. Alternatively, the exhaust of the vacuum source may be used as a compressor. Moreover, the system may further include a compressor to be used in conjunction with the hair and nail dryers, and the airbrush. Additionally, the system may include a sandblasting device for face and body treatment, devices for oxygen, ozone, steam, gentle lymphatic massage, and cupping treatments, and an erection massage device. The system may be provided in male and female versions, as well as in versions for the home and for clinics.

The principles and operation of a the device and method according to the present invention may be better understood with reference to the drawings and accompanying descriptions.

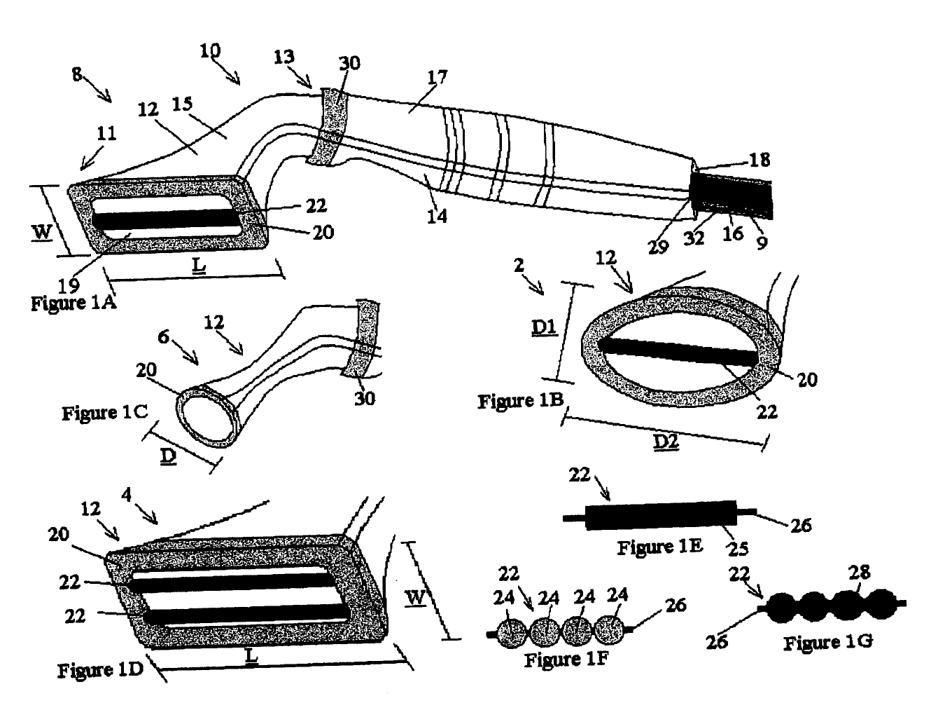

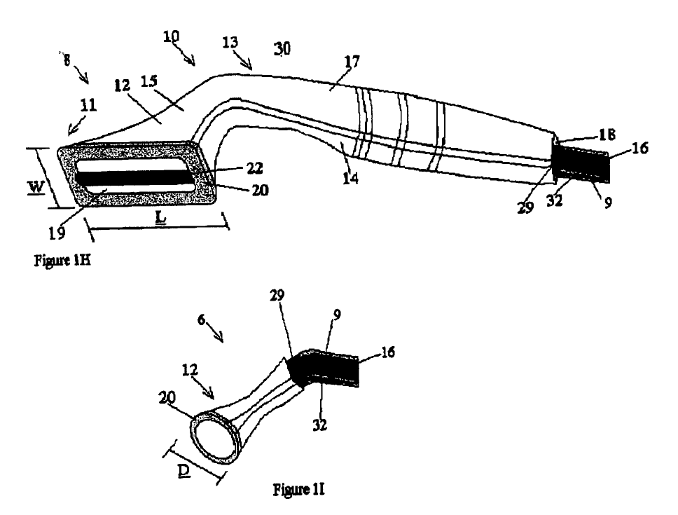

Referring now to the drawings, FIGS. 1A-1I schematically illustrate a device 10 for face and body treatment, in accordance with a preferred embodiment of the present invention. Device 10 is a massage device, which employs suction, imitating the conventional massaging method, “palpate and roll”, and stimulating blood circulation.

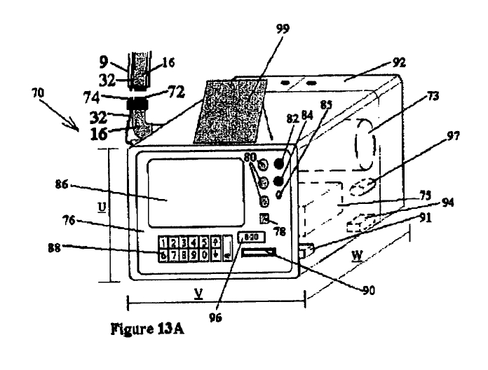

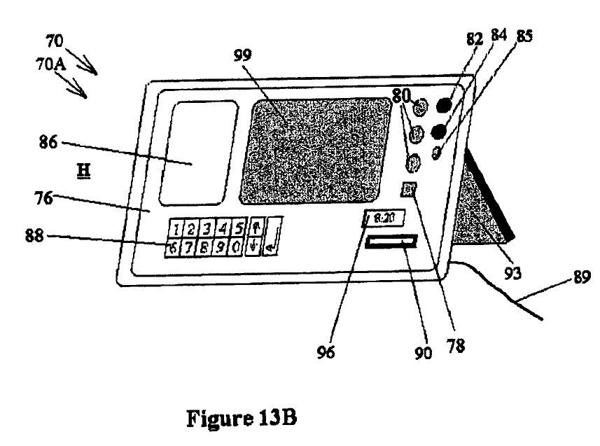

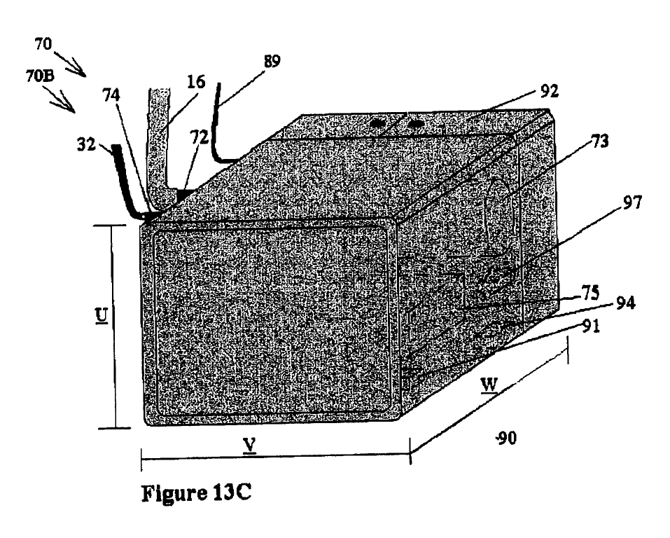

Device 10 includes a spout 12, adapted for gliding along a portion of a body and applying suction thereto. Spout 12 has proximal and distal ends, 11 and 13, with respect to the body, and a casing 15, which defines an inner chamber 19 therein, operative at a pressure below atmospheric pressure, for applying suction to the tissue. Spout 12 is attached to a gripping handle 14, at distal end 13. Gripping handle 14 has a casing 17, which defines a lumen 18, wherein a vacuum hose 16 is arranged, for providing suction to spout 12. Additionally, a power-and-control line 32, described hereinbelow in conjunction with FIGS. 13A-13C, is embedded within casing 15, or within lumen 18. Preferably, vacuum hose 16 and power-and-control line 32 reach device 10 together, enclosed within a sheath 9. Alternatively, they may reach device 10 separately. A connector 7, for selectively connecting and disconnecting device 10

Preferably, gripping handle 14 connects with vacuum hose 16 and power-and-control line 32 via a connector 29. Connector 29 may also have a swivel motion, for example of 90 or 120 degrees. Connector 29 may be located on device 10 or along vacuum hose 16 and power-and-control line 32.

Preferably, device 10 is aesthetically designed and colored. A choice of colors may be provided. Casing 15 of spout 12 and casing 17 of gripping handle 14 may be formed of a rigid plastic, for example, PVC, a combination of wood and plastic, a combination of natural or synthetic rubber and plastic, or the like.

At proximal end 11, spout 12 has a surface 20, which makes contact with the portion of the body under treatments as device 10 glides along it. Surface 20 may be elliptical, circulars rectangular or of another shape, and is preferably formed as a replaceable pad, preferably of silicon, or another material that is preferably biocompatible, nonallergenic, and soft to the touch. During use, a lubricant, such as a facial cream or a gel may be used between surface 20 and skin 40.

In accordance with a preferred embodiment of the present invention, a plurality of spouts 12 may be provided, of different sizes and shapes, each adapted for a particular portion of the body. For example, for applying suction generally to the face, a rectangular spout 8 of FIG. 1A, for example, having a length L substantially of 25 mm, and a width W substantially of 10 mm, with an inner roller of substantially 3 mm in diameter, may be used. Alternatively, an elliptical spout 2 of FIG. 1B, for example, having a minor diameter D1 substantially of 10 mm, and a major diameter D2 substantially of 25 mm, may be used. Alternatively, a circular spout 6, of FIG. 1C, for example, of a 30-mm circular cross, section may be used. Yet, for the area under the eyes, circular spout 6 of FIG. 1C, may have a diameter of between 4 and 15 mm. For applying suction to other portions of the body, for example, the thighs; a double-roller rectangular spout 4 of FIG. 1D, which is much larger than that of FIG. 1A, and may be, for example, substantially of 75 mm in length, and 35 mm in width, may be chosen. It will be appreciated that these choices are individual, and different users may select differently. It will be further appreciated that other dimensions may similarly be used.

Spout 12 way be affixed onto gripping handle 14 in a manner similar to that by which different attachments are affixed onto a vacuum cleaner. For example, gripping handle 14 may include a connector 30, operative as a socket, for receiving distal end 13 of spout 12. Preferably connector 30 has a swivel motion, for example of 90 or 120 degrees.

Alternatively, spout 12 may be permanently connected to gripping handle 14.

Additionally, device 10 may include at least one roller 22, arranged at proximal end 11, and protruding proximally from surface 20, for increasing the massaging action to the portion of the body under treatment. As shown in FIG. 1E, roller 22 may be a cylinder 25, arranged on a shaft 26. Alternatively, as shown in FIG. 1F, roller 22 may include balls 24 arranged on shaft 26. Alternatively, as shown in FIG. 1G, roller 22 may have a wavy structure 28, arranged on shaft 26. Alternatively, another roller may be used. Roller 22 may be formed, for example, of rigid plastic, PVC, wood, natural or synthetic rubber, or another suitable material. Alternatively, a bar 22, which does not rotate with the motion of spout 12, may be used.

Preferably, roller 22 may be selectively inserted into spout 12 when a massaging action is desired, and selectively removed from spout 12, for suction without massage. Additionally, spout 12 may be provided with several rollers 22, for example, from amongst those seen in FIGS. 1E-1G, and a user (not shown) may select roller 22 of a desired shape. Furthermore, spout 12 may be adapted to include two or more rollers, as seen in FIG. 1D. Preferably, roller 22 is manually powered, arranged to roll as spout 12 glides along the portion of the body under treatment. Alternatively, roller 22 may be electrically powered.

In accordance with the present invention, the actions of both casing 15 and at least one roller 22 are denoted macro-massage, to distinguish them from electrically assisted forms of treatment that may involve micro-massage, for example, ultrasound.

As seen in FIG. 1H, spout 12 and device 14 may be integrated into a single unit, forming device 10, adapted to fit into connector 29, in a manner similar to that by which different attachments are affixed onto a vacuum cleaner. A plurality of devices 10 may be provided.

Alternatively, gripping handle 14, or device 10, may be permanently connected to vacuum hose 16 and power-and-control line 32.

Alternatively as seen in FIG. 1I, spout 12 may be directly adapted to fit into connector 29, in a manner similar to that by which different attachments are affixed onto a vacuum cleaner.

Alternatively, spout 12, forming device 10, may be permanently connected to vacuum hose 16 and power-and-control line 32

may be permanently connected to vacuum hose 16 and power-and-control line 32.

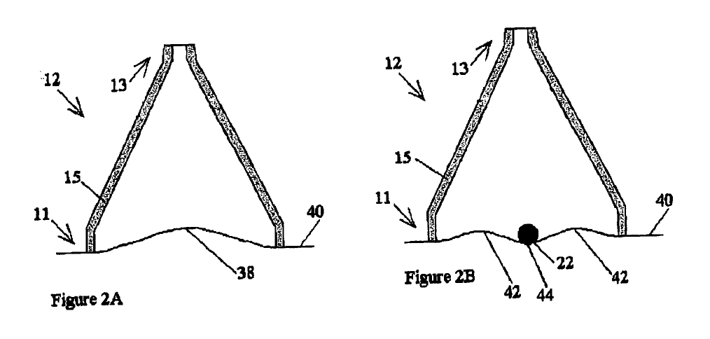

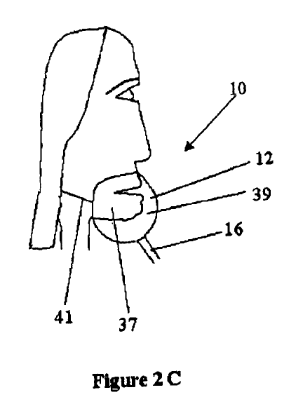

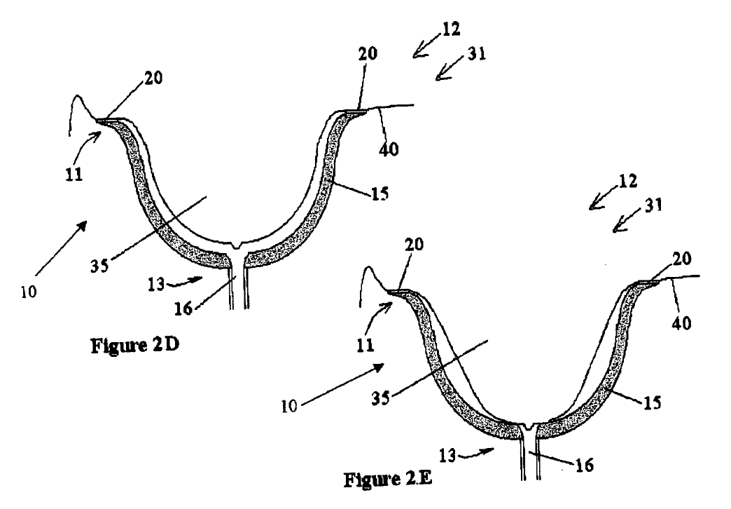

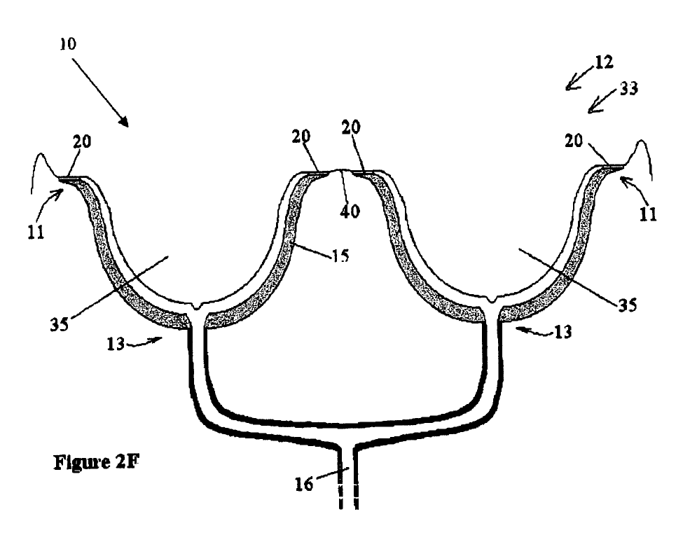

Referring further to the drawings, FIGS. 2A-2B schematically illustrate spouts 12, for applying suction to skin 40, in accordance with preferred embodiments of the present invention.

As seen in FIG. 2A, when suction is applied to skin 40, a skin bump 38 is formed within spout 12. As device 10 is moved across the body, skin hump 38 is rolled over by casing 15, to produce the massaging action.

It will be appreciated that the suction may be steady or pulsating, with varying pulsation duration and suction power. Additionally, pulsating suction may include pauses, for example:

i. a pulse may include: suction-pause-release;

ii. a pulse may include: suction-pause-release-pause; and

iii. a pulse may include: suction-release.

The length of each pulse may vary, for example, from 0.1 seconds to 5 seconds. It will be appreciated that other values may similarly be used. The time division between the portions of the pulse, for example, suction, pause, and release, may be equal or different.

As seen in FIG. 2B, when suction is applied, while roller 22 presses down on skin 40, two skin humps 42 arc formed, separated by a skin depression 44, that is created by roller 22. Thus both casing 15 and roller 22 participate in the massaging action. It will be appreciated that roller 22 may be motorized or may rotate freely with the movement of spout 12.

It will be appreciated that the vacuum, may be a pulsating a steady.

In accordance with the present invention, the actions of both casing 15 and at least one roller 22 will be denoted macro-massage, to distinguish them from electrically assisted forms of treatment that may involve micro-massage, for example, ultrasound.

The range of vacuum may be, for example, between −350 and −500 mbars. Alternatively, it may be, for example, between −250 and −700 mbars. Alternatively, it may be, for example, between −25 and −900 mbars. It will be appreciated that other values may also be used.

The capacity may be, for example, between 200 and 400 liters per minute. Alternatively, it may be, for example, between 100 and 600 liters per minute. Alternatively, it may be, for example, between 50 and 1000 liters per minute. It will be appreciated that other values may also be used.

Clinical tests by LPG, (“Clinical and Skin Tissue Effects of Lift 6®, Dermexpert Laboratory, LPG Systems, France, 2001) show that facial suction treatment, for example by spout 12 of FIG. 2A, tends to firm, and improve loose facial skin. Twenty four women with signs of loose face skin were evaluated clinically. The treatment schedule included 20 sessions during 8 weeks, as follows: three sections a week for the first four-week period and two sections a week for the second four-week period. The clinical evaluations included the following:

1. Cutaneous biopsies of elastic fibers (thin cut) in the papillary dermis showed an increase in oxytalan fibers, after the treatment. The oxytalan fibers were thick, well structured and perpendicular to the dermo-epidermal junction. Additionally the elastic fibers of the papillary dermis, themselves, were better structured.

2. Cutaneous biopsies of elastic fibers (thick cut) showed a thicker elastin network, after the treatment.

3. Cutaneous biopsies (thin cut) in the papillary dermis and superior reticular dermis showed denser collagen networks after the treatment.

4. The number of “crow's foot” wrinkles around the eyes decreased by about 17% and their depth decreased by about 22%, after the treatnent.

Additionally, 73% of the women felt there was an improvement in their facial skin quality, after the treatment. For 52% of the women, sufficient improvement was maintained even two weeks after the treatment had ended.

Referring further to the drawings, FIG. 2C schematically illustrates spout 12, for applying suction to a chin and lower face area 37, in accordance with a preferred embodiment of die present invention. Preferably, spout 12 of the present embodiment has a shape 39 which is similar to that of a gas mask. Spout 12 of the present embodiment may be attached with a strap 41.

Clinical tests, by LPG, as described hereinabove, show a lower-chin volume decrease in, 54% of the patients, after the four weeks of treatment, and in 70% of the patients after eight weeks of treatment.

Referring further to the drawings, FIGS. 2D-2E schematically illustrate device 10, which includes spout 12, shaped as a bra cup 31, for breast firming, by applying suction to a breast 35, in accordance with a preferred embodiment of the present invention. FIG. 2D illustrates a rest situation and FIG. 2E illustrates breast 35 under suction.

Preferably, bra cup 31 includes pad 20, which forms a seal with skin 40. Bra cup 31 may be provided in a range of sizes, preferably analogous to bra sizes. Spout 12 of the present embodiment may be attached to the body (not shown) with straps 41 (FIG. 2C).

Referring further to the drawings, FIG. 2F schematically illustrates device 10, wherein spout 12 is shaped as a double spout, forming bra cups 33, for breast firming, by applying suction simultaneously to the two breasts 35, in accordance with another preferred embodiment of the present invention. Pad 20, which preferably forms a seal with the skin, may form a bridge between two bra cups 33. Alternatively, they are maneuvered generally independently. Double spouts 12 of the present embodiment may be attached to the body (not shown) with straps 41 (FIG. 2C).

Preferably, suction to breasts 35 is applied in pulses, of between 1 and 15 seconds each, and preferably of 2-3 seconds each. The amplitude of the suction pulse may be between −25 and −350 mm Hg. Preferably, the suction pulses have a sharp rise and a relatively slow decay. Alternatively, square or sinusoidal pulses may be used.

Clinical tests by LPG, as described hereinabove, show that suction treatment tends to firm, lift and improve the shape of pendulous breasts. For example, given a treatment schedule of 12 sessions during four weeks (three times a week, for 20 minutes), for 19 Caucasian women between the ages of 26 and 43, 84% of the women reported a lifting effect, that remained even two weeks after the treatment had ended. The lifting effect was expressed by a decrease in the distance between the shoulder and the nipple, from an average of 21.12 cm before the treatment, to 20.41 after two weeks of treatment, 20.55, at the end of the four-week treatment, and 20.68, two weeks after the end of the treatment.

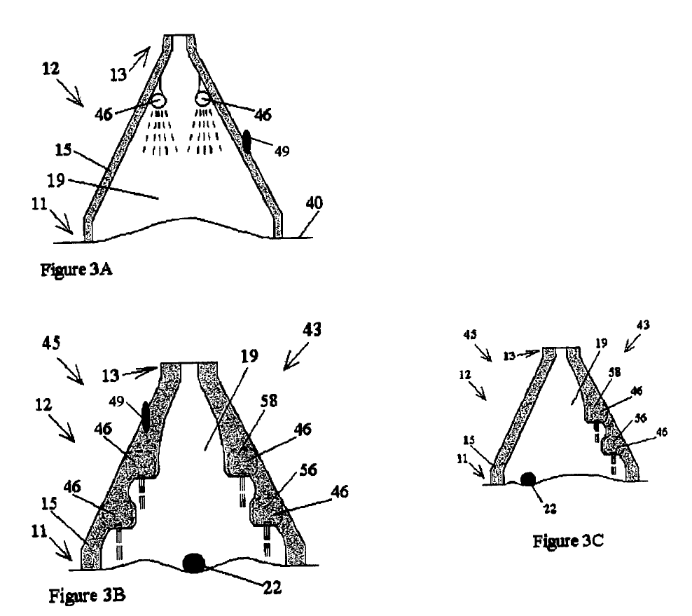

In accordance with the present invention, device 10 further includes at least one feature, integrated with spout 12, for applying at least one mode of treatment, for example, selected from the group consisting of warming light treatment, infrared light treatment UV light treatment, Low Level Laser Treatment (LLLT), pulsating magnetic field treatment, constant magnetic field treatment, electrostimulation treatment, cooling-diode treatment, warming-diode treatment, mechanical epilation and photoepilation, as described hereinbelow, in conjunction with FIGS. 3A-15

Referring further to the drawings, FIGS. 3A-3B schematically illustrate spouts 12, comprising at least one light source 46, for providing light treatment, in accordance with preferred embodiments of the present invention. Light treatment may comprise an infrared light treatment, for example, for providing primarily a warming effect to the tissue, and for cell reneal, UV light treatment, for phototreatment of dermatoses, especially psoriasis, and LLLT. It will be appreciated that a combination of these may be employed, in tandem or in sequence. It will be further appreciated that other forms of light treatment are also possible.

As seen in FIG. 3A, warming light treatment may be provided with at least one light source 46 of one or several incandescent light bulbs, and (or) one or several halogen tubes, and (or) one or several infrared light sources, arranged within inner chamber 19 of spout 12. Preferably, a knob 49 may be used to turn off at least one light source 46, so as to apply vacuum only, when desired. It will be appreciated that knob 49 may be located on spout 12 or on gripping handle 14, of device 10.

Additionally or alternatively, infrared light treatment may be provided by providing one or several infrared light sources 46, for example, arranged within inner chamber 19 of spout 12.

Alternatively, UV light treatment may be provided, for example by employing light source 46 as a low-pressure mercury vapor discharge lamp, as taught by U.S. Pat. No. 4,354,139, to Konijnendijk, et al., whose disclosure is incorporated herein by reference.

Alternatively, as seen in FIG. 3B, LLLLT may be provided by employing at least one light source 46 of one or several laser light sources, for example, laser diodes, preferably imbedded within casing 15. Preferably, knob 49 may be used to turn off at least one light source 46, so as to apply vacuum only, when desired.

According to Skylark Inc. “Laser Treatment, http://www.skylarkdevice.com/english/laser_e.htm, 2000-2001 and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATP), and increases the synthetic energy of nucleic acid. Additionally, LLLT can stimulate the skin to improve its tension and elasticity, reduce wrinkles. remove scars, and slow down skin aging.

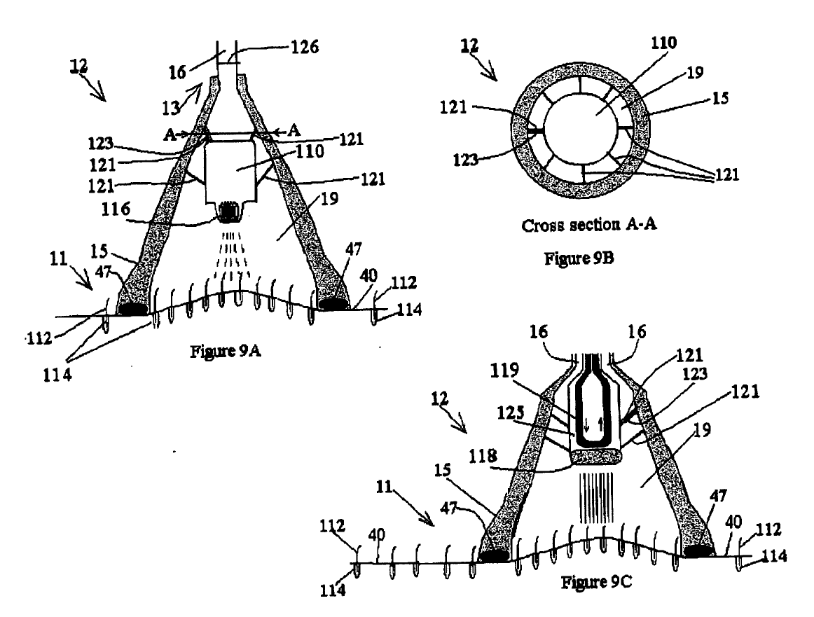

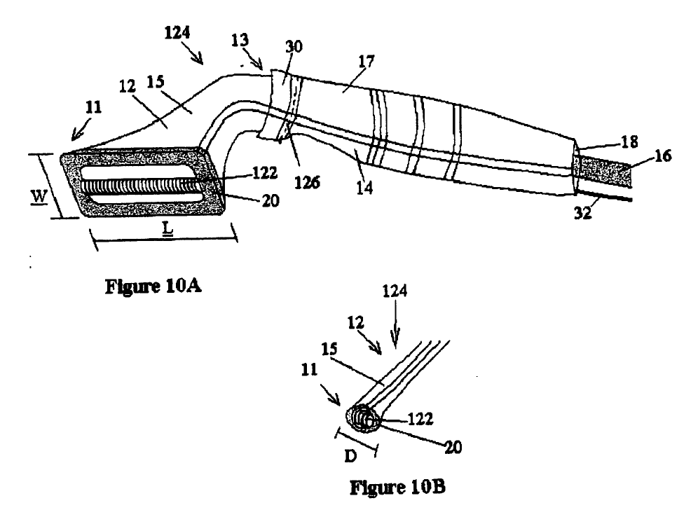

It will be appreciated that a cooling system may be used, for example, as described hereinbelow, in conjunction with FIG. 9B.

As seen in FIG. 3B, the laser light diodes may be arranged in a single tier of diodes, or as two or more tiers of diodes, for example, tiers 56 and 58, wherein each tier of diodes may include between one and four diodes. It will be appreciated that other numbers are also possible. The plurality of Laser light diodes may emit substantially the same wavelength. Alternatively, two or more wavelengths may be used, as taught, for example, by U.S. Pat. No. 4,930,504 to Diamantopoulos, and by U.S. Pat. No. 5,755,751, to Eckhouse, whose disclosures are incorporated herein by reference. For example, tier 56 may operate at a first wavelength, tier 58 may operate at a second wavelength, and additional tiers may he employed, operating at other wavelengths.

The laser light diodes may he pulsed or continuous. When pulsed laser is used, pulsation may take place between a left side 45 and a right side 43, or between tiers of diodes such as tiers 56 and 58. Where more tiers are used, they may be pulsed in sequence. Additionally or alternatively, where two or more wavelengths are employed, they may be pulsed in sequence.

When using laser light source, eye pads (not shown), are worn, for protection. Alternatively, special protective glasses (not shown) may be provided with device 10.

Irradiation by the two or more wavelengths may be simultaneous. Alternatively, it may be sequential. Alternatively, the user may select a predetermined radiation schedule, which may be simultaneous, sequential, or restricted to only one or only two wavelengths from amongst the wavelengths that are available.

The irradiation wavelength range may be from below 200 to above 1500 nm. Specifically, the range 630-1200nm may be used for biostimulation. The range 305-320 nm may be used for the treatment of psoriasis and other skin diseases. Additionally, as taught by U.S. Pat. No. 5,755,751, to Eckhouse, other wavelengths for example in the range 400-600, may be employed.

Laser light diodes 46 may be obtained, for example, from Photonic Devices. http://www.photonics.com. Alternatively, they may obtained from Coherent, www.coherent.com, which provide miniature laser diodes, of generally less than 10 mm in diameter and 2-3 mm in height.

It will be appreciated that a cooling system may be used, for example, as described hereinbelow, in conjunction with FIG. 9B.

FIG. 3C illustrates a different arrangement of roller 22 and light diodes 46, which is not symmetric.

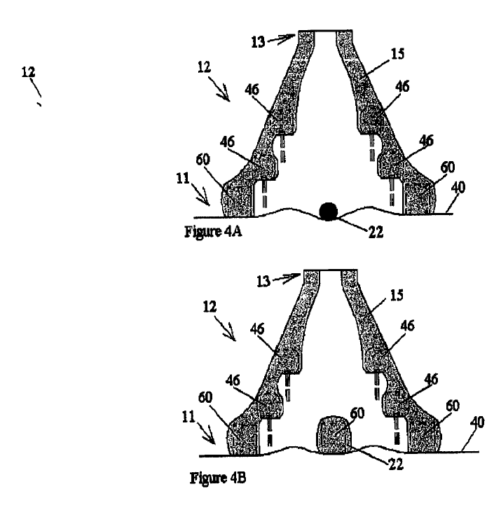

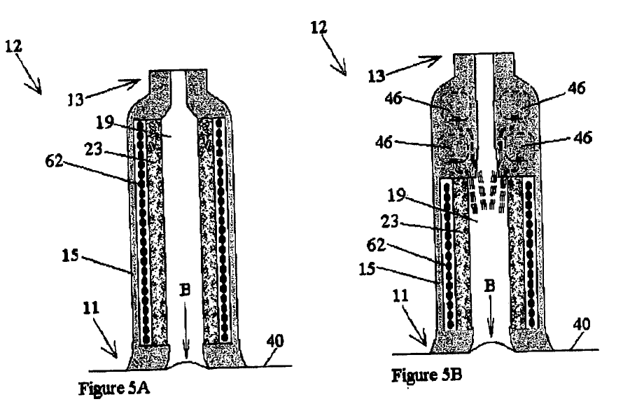

Referring further to the drawings, FIGS. 4A and 4B schematically illustrate spouts 12, comprising an ultrasound transducer 60, in accordance with preferred embodiments of the present invention, for providing ultrasound treatment.

According to “Ultrasound Treatment,” Skylark Inc., http://www.skylarkdevice.com/english/ultrasonic_e.htm#head, Ultrasound causes a massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitation of the interface material, which leads to a cleansing of the skin. Additionally, ultrasound increases skin absorption of external matter.

Additionally, according to U.S. Pat. No. 6,325,769, whose disclosure is incorporated herein by reference, controlled application of ultrasound energy into the dermis layer reduces the extent of wrinkles and rejuvenate the skin. The ultrasound energy triggers a biological response that causes a synthesis of new connective tissue in the dermis through activation of fibroblast cells in the dermis without causing or requiring a significant irritation or a damage to the epidermis.

As seen in FIG. 4A, at least one, and preferably several ultrasound transducers 60 may be arranged within casing 15, so as to have direct contact with skin 40. Alternatively or additionally, one or several ultrasound transducers 60 may be arranged within roller 22, or bar 22, so as to have direct contact with skin 40. During use, a lubricant, such as a facial cream or a special gel may be used between surface 20 (FIG. 1A) and skin 40. Alternatively, collagen cream, or another beneficial cream may be used and absorbed by the skin as a result of the ultrasound action.

When using a continuous waveform, the frequency range may be about 1-5 MHz, at a recommended power of about 1 W/Li², for a treatment time of about 15 minutes, for general muscle treatment. The recommended power is about 0.5 W/Cm², and the recommended treatment time is about 8-10 minutes, for facial treatment. Alternatively, when using a pulse waveform, the recommended power is about 240 mW/cm², for about 15 minutes, for general muscle treatment, and about 120 mW/cm²W/cm², for about 8-10 minutes, for facial treatment. It will be appreciated that other values may be used.

Ultrasound transducer 60, in the frequency range between 50 kHz and 2 MHz at sizes as small as 0.2 in. external diameter and 0.36 in. in height, may be obtained, for example, from Digital Wave Corporation, 11234-A East Caley Av., Englewood, CO 80111 USA, Tel 303-790-7559, Fax. 303-790-7567, www.digitalwave.com. It will be appreciated that other values may be used.

As seen in FIGS. 4A and 4B, spout 12 may further include at least one light source 46, which may be any of the light sources described hereinabove, in conjunction with FIGS. 3A-3B. Preferably, the user may select either the a light treatment, such as LLLT treatment, or the ultrasound treatment, or both, in tandem or in sequence.

Referring further to the drawings, FIGS. 5A and 5B schematically illustrate spouts 12, comprising an electromagnet 62, for providing, pulsating magnetic field treatment, or constant magnetic field treatment, in accordance with preferred embodiments of the present invention.

According to “Magnetic and Electromagnetic Treatment,” By David Ramey, www.hcrc.orgaism/conntriib/ramey/magnet/html, Health Care Reality Check, downloaded on Nov. 20, 2001. some researchers believe that pulsating magnetic field may stimulate biological processes, pertinent for example, to osteogenesis, healing of chronic wounds, and neuronal regeneration, Preferably, electromagnet 62 comprises a conducting wire coil 62, arranged within casing 15. Additionally, an inner casing 23, preferably formed of a molded rigid plastic containing iron beads, iron filings, or the like, for example at a ratio of 1 part iron to 3 parts plastic, may be used on the side of conducting wire coil 62 facing inner chamber 19, to increase the magnetic field generated by conducting wire coil 62. Alternatively, another ratio may be used. Alternatively, no iron beads may be used. When current flows in wire coil 62, a magnetic field B is formed. To generate a pulsating magnetic field, a pulsed DC voltage may be used. For example, a pulsed DC voltage having a rectangular wave form, pulsing at the rate of 10-60 cycles per minutes (CPM), the coil producing an average field of between 5 and 25 gauss, may be used. It will be appreciated that other values may be used.

Alternatively, a constant DC voltage may be used, to form a constant magnetic field.

In accordance with the present invention, a permanent magnet may be used in place of wire coil 62, to form a constant magnetic field.

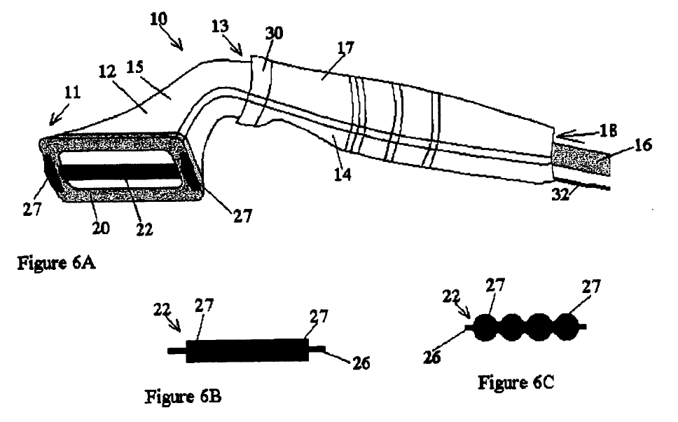

Referring further to the drawings, FIGS. 6A-6C schematically illustrate spout 12, comprising electrostimulating electrodes 27, for providing electrostimulation treatment, in accordance with preferred embodiments of the present invention.

As seen in FIG. 6A electrostimulating electrodes 27 may be arranged on surface 20. Alternatively, as seen in FIGS. 6B and 6C, electrostimulating electrodes 27 may be arranged on roller 22. Electrodes 27 may he formed, for example, of stainless steel, titanium, or titanium alloy or another preferably noncorrosive, biocompatible conducting metal.

Preferably, lectrostimulation treatment is performed at between 6 V and 64 V, and up to 15 mA. It will be appreciated that other values may be used. The electrostimulation current may be based on AC, DC, and DC pulses of varying duration, for example, between 0.1 and 20 Hz.

It will be appreciated that the vacuum, in accordance with the present embodiment, may be used to maintain the electrodes on the face or body.

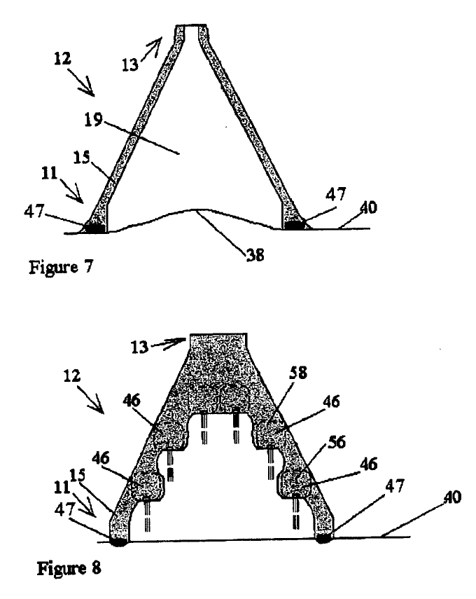

Referring further to the drawings, FIG. 7 schematically illustrates spout 12, comprising cooling diodes 47, arranged on surface 20, for providing cooling-diode treatment, in accordance with a preferred embodiment of the present invention Cooling-diode treatment may be desired, for example, to close the skin pores, at a conclusion of a treatment. Alternatively, cycles of heating and cooling may be employed, by combining for example, warming-light treatment and cooling-diode treatment.

Additionally, in accordance with an embodiment of the present invention, cooling diodes 47 may be selectively flipped by the user, when desired, so a to operate as warming diodes, for providing a warming effect or warming-diode treatment.

Preferably, diodes 47 operate at between 7-10° C. colder or warmer than the skin. However, other temperature values are also possible. Preferably, diodes 47 operate at 12 V and up to 7 amp. It will be appreciated that other values may be used.

Referring further to the drawings, FIG. 8 schematically illustrates spout 12, comprising laser diodes 46, embedded within casing 15, and cooling diodes 47, arranged on surface 20, for providing LLLT, in combination with cooling-diode treatment in accordance with a preferred embodiment of the present invention. It will be noted that spout 12 of FIG. 8 is not adapted for applying the suction, macromassage of FIGS. 2A-2B, but only other modes of treatment. Similarly, spout 12 may be adapted for light treatment with electrostimulation treatment, or ultrasound treatment with cooling diode treatment, or other combinations, in tandem or in sequence. Spout 12 may be further adapted for a combination of three or more modes of treatment, which may or may not include the suction, macro-massage of FIGS. 2A-2B.

Referring further to the drawings, FIGS. 9A and 9C schematically illustrate spouts 12, designed for light-induced hair removal, or photoepilation., in accordance with a preferred embodiment of the present invention.

As seen in FIGS. 9A and 9B, a photoepilation hair-removal device 110 may be attached to casing 15 of spout 12 by a structure 121, arranged for example, as a grid, so as not to block the suction in inner chamber 19. Additionally, power may be supplied to hair-removal device 110, via a powerline 123, which may be embedded within structure 121.

Photoepilation hair-removal device 10 is adapted to burn lairs 112 and roots 114, on skin 40. Preferably, photoepilation hair-removal device 110 is similar to the SpaTouch, described in http://198.174.40.227/new/radiancy/radiancy, as well as in U.S. Pat. No. 6,21.4,034, to Azar, entitled, “Method of selective photothermolysis,” and in U.S. Pat. No. 6.187,001, to Azar, et al., entitled, “Apparatus and method for removing hair,” whose disclosures are incorporated herein by reference. Thus, spout 12 of the present embodiment comprises a preferably pulsed light 116, which pulsates for example, in durations of 35 milliseconds, at a wavelength range favorable to melanin, over a very large spot size, for example, about 22×55 mm. It will be appreciated that other values may be used. Pulsed light source 116 may be a quarts light source.

It will be appreciated that although spout 12 seen in FIG. 9B is circular, other shapes, for example, rectangular, or elliptical may he used

It will be appreciated that cooling diodes 47 may be used against skin 40, to allevaiate the heat, generated by the photoepilation.

In accordance with the present invention, spout 12 applies suction to skin 40, for sucking the burnt hair ashes, through vacuum hose 16. A removable filter 126 may be used for collecting the ashes.

Spout 12 of the present embodiment can treat individuals with most skin and hair types. The procedure works best, however, for people with dark brown or black hair and a fair complexion because of the color contrast and the fact that darker hair has a higher melanin content. Areas of the body that have been exposed to the sun or ultraviolet light in tanning booths should not be treated until one month after exposure. Since dark colored hair tends to absorb light and burn more effectively than light colored hair, the user may dye hair 112, with a dye that infiltrates roots 114, prior to burning it. The dye may be a hair dye, as known, or liquid carbon, also known as Ferrite.

As seen in FIG. 9C, a laser photoepilation hair-removal device 125 may be attached to casing 15 of spout 12, for example, by structure 121. Additionally, power may be supplied to device 125 via powerline 123, which may be embeded within structure 121.

Laser photoepilation hair-removal device 125 may be basically similar to that of U.S. Pat. No. 6,273,885, to Koop, et al., Handheld photoepilation device and method, whose disclosure is incorporated herein by reference. Spout 12 of the present embodiment may thus inlcude a semiconductor diode 118 or diode array laser 118 which emit energy at wavelengths prefrably between about 630 nm and 980 nm, and delivers a predetermined amount of energy in a predetermined period of time. It will be appreciated that other values may be used.

Photoepilation hair-removal device 125 may include a cooling system 119, for example of water, air, or another fluid. The coolant system may be arranged within vacuum hose 16. Alternatively, spout 12 may include a finned, high heat-capacity material, as a heatsink, for passive cooling. Alternatively, another cooling system may be used, for example, cooling diodes.

It will be appreciated that powerline 123 may be arranged along cooling system 119.

Additionally, as in FIG. 9A, cooling diodes may be used against skin 40, to allevaiate the heat generated by the photoepilation.

In accordance with the present invention, spout 12 applies suction to skin 40, for sucking the burnt lair ashes.

Referring further to the drawings, FIGS. 10A-10B schematically illustrate spouts 12, designed as the Epilady, described in http://www.epiladyusa.com, as well as in U.S. Pat. No. 6,277,129, to Poran, entitled, “Dual ended hair remover,” whose disclosure is incorporated herein by reference, for mechanical hair removal, in accordance with a preferred embodiment of the present invention.

Thus, spout 12 of the present embodiments, operative as mechanical hair-removal device 124, has a series of high velocity rotating discs 122, operating like tweezers, that remove hair by the root. FIG. 10A illustrates a basic design, adapted for example, for women's legs, and FIG. 10B illustrates a miniature design, adapted for example, for facial hair, or as a sensitive trimmer for intimate areas.

In accordance with the present invention, inner chamber 19, around series of high velocity rotating discs 122, applies suction to the tissue, for sucking the hair away, through vacuum hose 16. A removable hair trap 126, or a hair filter 126, may be used for removing the hair.

Mechanical hair-removal device 124 may be attached to casing 15 of spout 12 by a structure 121, for example, as taught hereinabove, in conjunction with FIGS. 9A and 9B. Structure 121 is strong enough to withstand the vibrations of the mechanical epilation. Additionally, power may be supplied to hair-removal device 124, via powerline 123, embeded within structure, 121 (9A and 9B).

It will be appreciated that spouts 12, for example, as described in conjunction with FIGS. 1A-10B hereinabove need not be symmetric. For example, as described in conjunction with FIG. 3C, hereinabove.

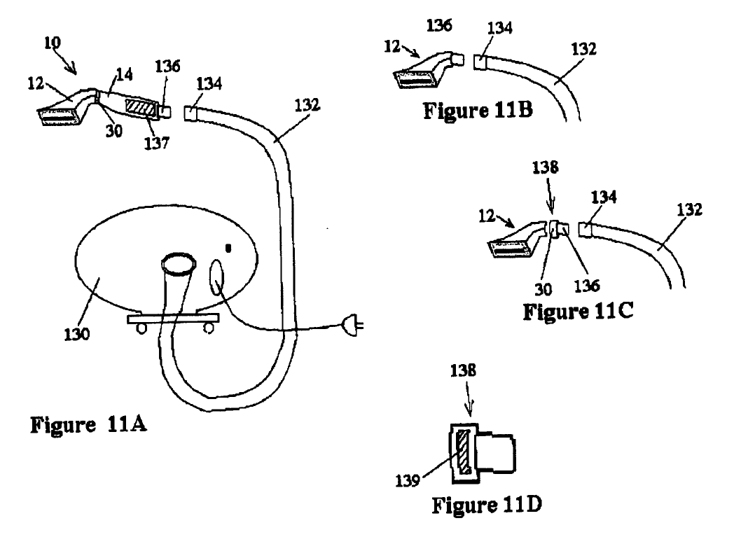

Referring further to the drawings, FIGS. 11A-11D schematically illustrate device 10 and spout 12, adapted for use with a standard vacuum cleaner 130, in accordance with preferred embodiments of the present invention.

As seen in FIG. 11A, device 10 may include a fitting 136, to enable use with a standard vacuum cleaner hose 132, having a fitting 134. Handle 14 of device 10 may further include a battery 137, for providing power to other features of spout 12, such as ultrasound or LLLT. Battery 137 may be rechargeable.

Alternatively, as seen in FIG. 11B, spout 12 may include fitting 136, to enable use with standard vacuum cleaner hose 132, having fitting 134.

Alternatively, as seen in FIG. 11C, a special adapter 138 may include fittings 136 and 134, to enable use with standard vacuum cleaner hose 132.

As seen in FIG. 11D, special adapter 138 may further include a battery 139, for providing power to other features of spout 12, such as ultrasound or LLLT. Battery 139 may be rechargeable.

Vacuum cleaner 130 may be a canister type vacuum cleaner, a brush type vacuum cleaner, a beater type vacuum cleaner, a hand-held, light, portable vacuum cleaner, such as a dust buster, a central, built-in vacuum cleaner, or any other vacuum cleaner, as known.

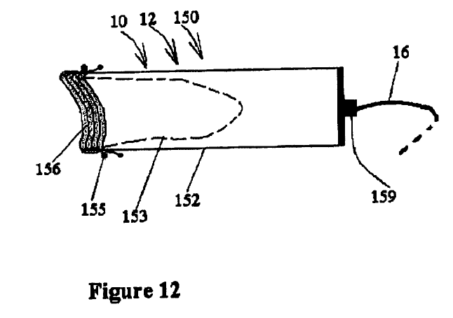

Referring further to the drawings, FIG. 12 schematically illustrates a spout, 12, designed as an erection implement 150, for treating impotence, in accordance with an embodiment of the present invention.

It is known that the application of vacuum to the penis is operative to bring about an erection. Spout 12 may be designed as erection implement 150, basically shaped as a soft, flexible hose 152, which connects to vacuum hose 16, via a connector 159. Additionally, flexible hose 152 includes a mouthpiece 156, adapted to form a seal with the body. Preferably, mouthpiece 156 is soft and flexible, formed for example, as an accordion, so as to adapt to the body shape. It will be appreciated that in accordance with the present embodiment, power-and-control-cable 32 need not be used.

In order to prevent fluids from reaching vacuum hose 16, a condom 153 may be used, inserted into erection implement 150, folded over the edges of mouthpiece 156, and held, for example, with a rubber band 155.

An erection may thus be Stimulated by the application of vacuum to flexible hose 152.

Referring further to the drawings, FIG. 13A schematically illustrates a power-and-control console 70, in accordance with a preferred embodiment of the present invention. Preferably, power-and-control console 70 is elegantly and attractively designed and colored. A choice of colors may be provided.

Power-and-control console 70 provides vacuum to vacuum hose 16, via a vacuum outlet 72, in communication with a vacuum source 73, and power to power-and-control line 32, via a power-and-control outlet 74, which may be, for example, a co-axial outlet, preferably receiving power from a power supply unit 75, and signals from a controller 91, described hereinbelow.

Additionally, power-and-control console 70 preferably includes a control panel 76, having an on/off control knob or control button 78 and preferably also several other knobs or button 80. Knobs 80 may be used to selectively activate different modes of treatment such as suction, macro-massage treatment, ultrasound treatment, pulsating magnetic field treatment, LLLT and others. Preferably, knobs 80 may also control the intensity and other variables of the treatment. For example, when ultrasound treatment is selected, knobs 80 may be used to select the desired frequency, the desired power range, and the desired duration of treatment. Similarly, when LLLT is selected, knobs 80 may be used to select the desired wavelength or wavelengths, the desired power range, and the desired duration of treatment. Additionally, knobs 80 may be used to select a treatment schedule, such as LLLT with suction massage, or LLLT directly after tile suction massage, or another treatment schedule.

Knobs 78 and 80 may also be located directly on gripping handle 14. This allows the user to initially turn device 10 on from power-and-control console 70, but pause or change treatment modes directly from gripping handle 14.

Additionally, control panel 76 may also include a display panel 86, which may display the feature or schedule that was selected. Display panel 86 may be interactive, so the user may touch it to select features or schedules. Alternatively or additionally, a keyboard 88 may be provided, for selecting a desired feature or schedule.

Power-and-control console 70 may further include a controller 91 or a microcomputer 91, which may also include a memory. A read/write storage system 90 such as a diskette drive, a CD drive, or a mini CD drive may be used for storing or reading specific schedules.

Furthermore, power-and-control console 70 may include a clock 96, which is preferably digital, to clock the duration of a treatment.

Additionally, power-and-control console 70 may include a preferably rechargeable battery 94.

Preferably, control panel 76 also includes a light 82, for indicating that the system is on. Preferably a second light 84 may be provided as a warning light, for example, when the treatment time, or requested power level exceeds a recommended value. When this happens, controller 91 may stop the treatment.

Additionally, power-and-control console 70 may include a thermostat. A third light 85 may serve as a warning light, to indicate when power-and-control console 70 overheats When this happens, controller 91 may stop the treatment.

Furthermore, power-and-control console 70 may include a short-circuit protection 97.

Preferably, a length V of power-and-control console 70 is 36 cm, a width W is 24 cm, and a height U is 13 cm. It will be appreciated that other dimensions are possible.

Power-and-control console 70 may further include a storage box 92 for storing accessories such as different spouts 12 and rollers 22, and a mirror 99, for allowing the user to view a facial treatment. Preferably, mirror 99 may be folded flat.

Referring further to the drawings, FIGS. 13B-13C schematically illustrate power-and-control console 70, in accordance with another preferred embodiment of the present invention. Preferably, power-and-control console 70 is formed of a control-and-display portion 70A and a power-and-vacuum portion 70B. Power-and-vacuum portion 70B may be stored in a cabinet, or under a table, while control-and-display portion 70A, which may further include a support back 93, may be easily accessible—kept over a table, or over a chest, or bung on the wall, or over a mirror. Control-and-display portion 70A is preferably elegantly and attractively designed and colored. A cable 89 may be used to connect control-and-display portion 70A and power-and-vacuum portion 70B.

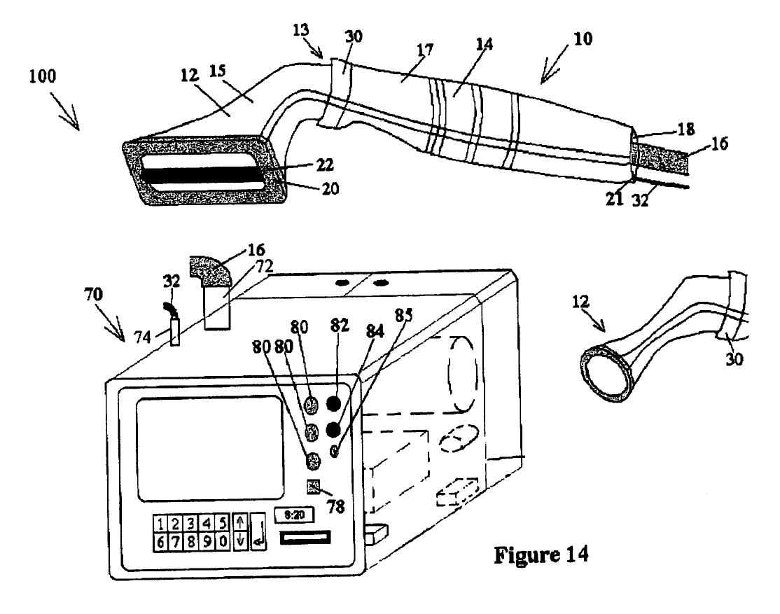

Referring further to the drawings, FIG. 14 schematically illustrates a system 100, comprising power-and-control console 70 and device 10, in accordance with a preferred embodiment of the present invention. Device 10 includes at least one, and preferably two or more spouts 12.

Preferably, power-and-control console 70 is lightweight and portable, making system 100 portable. When battery 94, which is preferably rechargeable, is used, system 100 may be used “on the go.” Preferably power-and-control console 70, device 10 and spouts 12 are arranged in an attractive carrying case, wherein power-and-control console 70 may be built into the carrying case.

In accordance with a preferred embodiment of the present invention, a plurality of spouts 12 may be provided, each having different features, adapted for a different modes of treatment and (or) different portions of the body. The different modes of treatment may include:

1. suction, macro-massage treatment, which may include one or more rollers (FIGS. 1A-1I, and 2A-2B);

2. lower-chin firming treatment (FIG. 2C);

3. breast firming treatment (FIG. 2D-2F);

4. light treatment (FIGS. 3A and 3B), which includes:

i. warming light treatment, (based on any one of infrared light, incandescent light or halogen light);

ii. infrared light treatment;

iii. UV light treatment;

iv. LLLT;

5. ultrasound treatment (FIGS. 4A-4B);

6. magnetic field treatment (FIGS. 5A-5B) which includes;

i. pulsating magnetic field treatment; and

ii. constant magnetic field treatment;

7. electrostimulation treatment (FIGS. 6A-6C);

8. cooling-diode treatment (FIG. 7);

9. warming-diode treatment (FIG. 7);

10. photoepilation (FIGS. 9A-9C);

11. mechanical epilation (FIGS. 10A-10B); and

12. impotence treatment (FIG. 12);

13. various combinations (4A, 4B, 5B and 8)

In addition, spout 12 may combine several features, such as LLLT and ultrasound (FIGS. 4A and 4B), or LLLT and pulsating magnetic field treatment (FIG. 5B) Similarly, other combinations are possible. These nay be applied in tandem, in sequence, in accordance with predetermined schedules, or at different times.

For example, spout 12 may be adapted for suction massage, and may further include laser diodes tiers 56 and 58 imbedded in casing 15 (FIG. 3B), cooling diodes 47 (FIG. 7), and ultrasound transducer 60, imbedded in roller 22 (FIG. 41B). A predetermined schedule, using spout 12, may comprise,

1. a first period of 10 min.: suction, macro-massage treatment with LLLT;

2. a second period of 5 min.: ultrasound treatment; and

3. a third period of 3 min.: cooling-diode treatment.

Alternatively, spout 12 may be adapted for suction massage, and may further include infrared light 46 (FIG. 3A), cooling diodes 47 (FIG. 7) and electrostimulating electrodes 27 (FIG. 6A-6C). A predetermined schedule, using spout 12 may comprise,

1. a first period of 8 min.: suction, macro-massage treatment with infrared light treatment;

2. a second period of 8 min.: electrostimulation treatment; and

3. a third period of 3 min.: cooling-diode treatment.

It will be appreciated that many other predetermined schedules are similarly possible. Additionally, it will be appreciated that spout 12 may be used for the application of a single treatment, such as only suction, macromassage treatment, only LLLT, or only ultrasound treatment.

Thus, in accordance with the present invention, self-application of a variety of face and body treatments is possible with device 10. The user may adhere to a predetermined schedule, or alternate between schedules, for example, a first predetermined schedule on Sundays and Tuesdays, a second predetermined schedule on Mondays and Wednesdays, and a third predetermined schedule on Fridays. Preferably, the schedules are based on clinical recommendations for the frequency and duration of different forms of treatment. Recommended predetermined schedules may be provided on diskettes, CD's, or the like, with system 100.

Preferably, device 10 further includes knob 49 (FIGS. 3A-3B) to turn off any or all features, other than vacuum, when desired. Knob 49 may be located on spout 12 or on gripping handle 14, of device 10.

It will be appreciated that spout 12 and device 14 may be integrated into a single unit, forming device 10, and a plurality of devices 10 may be provided, rather than plurality of spouts 12.

It will be appreciated that spout 12 or device 10 may be connected to a vacuum cleaner, as described in any of FIGS. 11A-11D.

It will be appreciated that vacuum hose 16 and power-and-control-cable 32 may be attached to device 10, with a detachable connector 29 (FIG. 1A) to power-and-control-console 70. Alternatively, they may be attached to power-and-control-console 70 with detachable connectors 72 and 74 (FIG. 13A). Additionally, only one of vacuum hose 16 and power-and-control-cable 32 may be used with a device 10.

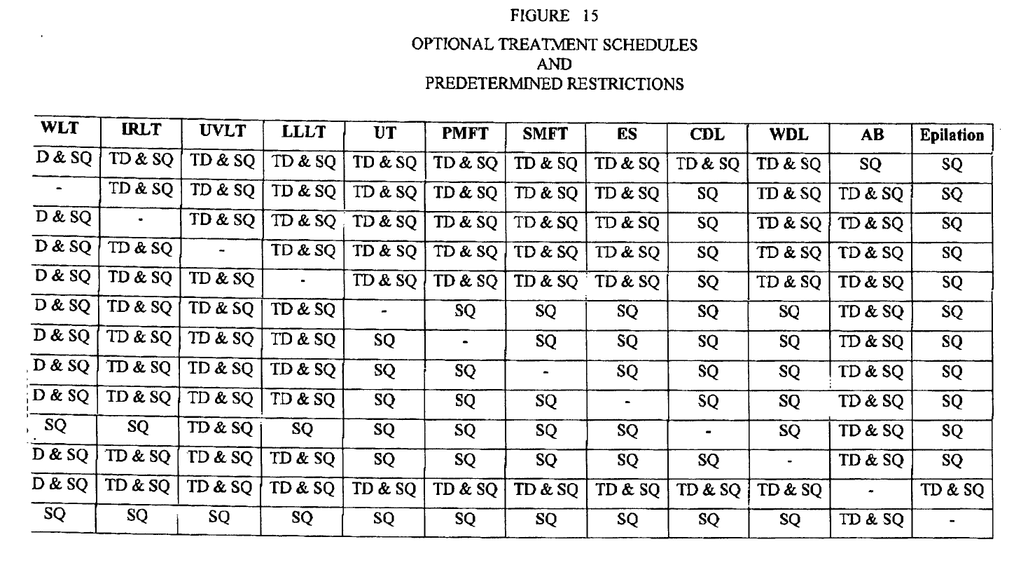

Referring further to the drawings, FIG. 15, which is arranged as a table, delineates certain predetermined restrictions regarding the different features and different modes of treatment of device 10, in accordance with the present invention. Certain modes of treatment, such as suction, macromassage treatment and light treatment may be applied in tandem and in sequence. On the other hand, other modes may be applied only in sequence, as they interfere with each other. For example, electrostimulation is likely to interfere with the operation of a piezoelectric ultrasound transducer, thus tandem application of electrostimulation and ultrasound treatments is restricted. Similarly, cooling treatment will be ineffective, when conducted with warming light treatment, infrared light treatment, or with ultrasound treatment, all of which having warming effects on the tissue. In consequence, their tandem application is restricted. The key to the acronyms of FIG. 15 is as follows:

SM—suction, macro-massage treatment, with or without one or more rollers;

WLT—warming light treatment (based on any one of infrared light, incandescent light or halogen light);

IRLT—infrared-light treatment

UVLT—ultraviolet-light treatment;

LLLT—low level laser treatment;

UT—ultrasound treatment;

PMFT—pulsating magnetic field treatment;

SMFT—constant magnetic field treatment;

ES—electrostimulation treatment;

CDL—cooling-diode treatment;

WDL—warming-diode treatment;

AB—air blowing

epilation—photoepilation or mechanical epilation;

TD & SQ—in tandem and in sequence; and

SQ—only in sequence.

It will be appreciated that a cooling system may be used with any of spouts 12, for example, as described in conjunction with FIG. 9B.

It will be appreciated that an oil or a cream, which may be for example, a baby oil, a body lotion, a hand cream, a facial cream, a facial Ionic, an aromatic oil or an aromatic cream may be used together with spout 12. However, spout 12 may also be used with no oil or cream.

In accordance with another preferred embodiment of the present invention, the user may buy system 100 with a limited number of spouts 12. Additionally, the user may upgrade his system 100 by buying additional spouts 12 at a later time.

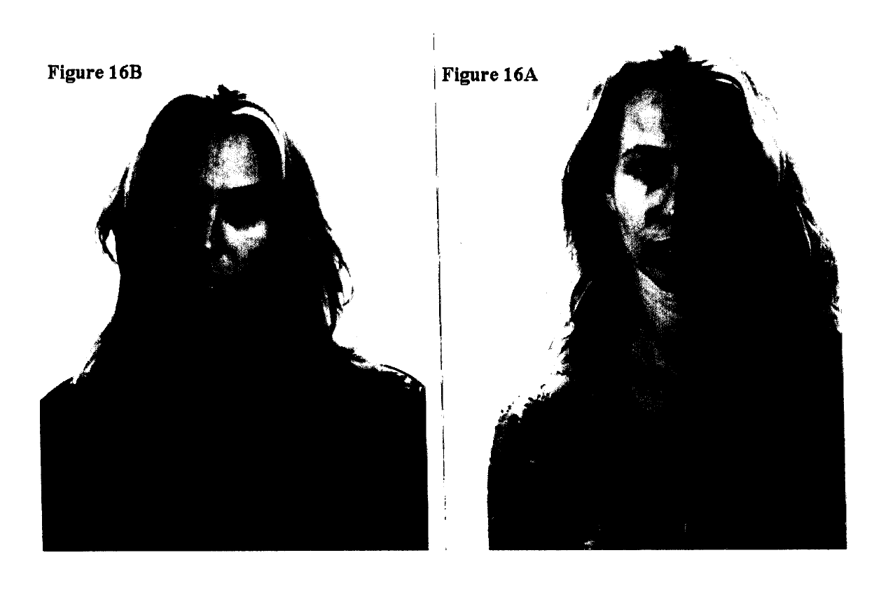

Referring further to the drawings, FIGS. 16A-16B are colored photographs of a 36-year old woman that underwent a vacuum treatment, in accordance with the present invention. FIGS. 16A was taken prior to the treatment and FIG. 16B was taken after two months of treatment. The treatment schedule was as follows:

During the 1^{st} week: 5 min., 2-3 times a week, at 0.3-0.5 of 450 mbars.

During the 2^{nd} week: 5 min., 2-3 times a week, at ˜0.6 of 450 mbars.

During the 3^{rd} week: 5 min., 2-3 times a week, at 0.9-1.0 of 450 mbars.

After the 3^{rd} week: 5 min., 2-3 times a week, at 450 mbars.

After two months: 5 min., once a week, at 450 mbars to retain the effect.

As seen when comparing FIGS. 16B and 16A, there is a marked improvement in facial tone, after two months of treatment.

It will be appreciated that the vacuum treatment schedule hereinabove is merely an example, and other treatment schedules arc similarly possible.

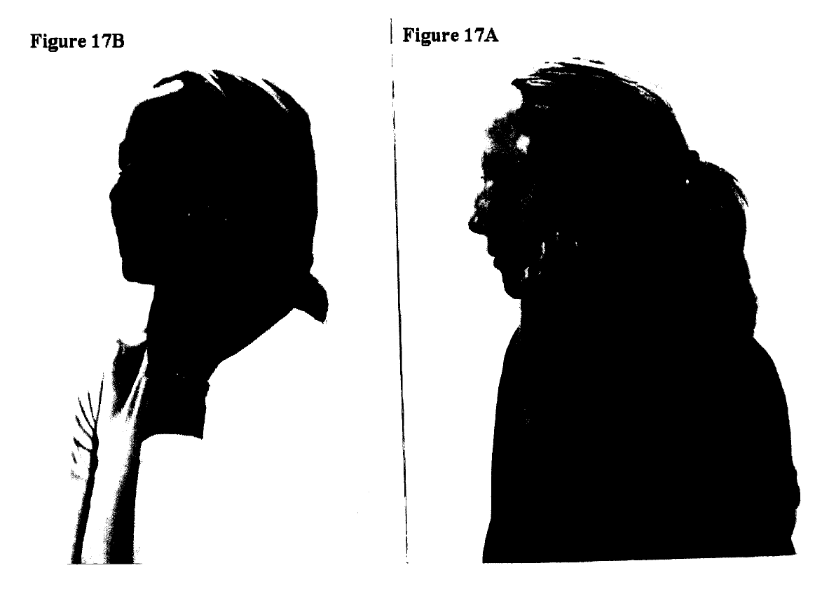

Referring further to the drawings, FIGS. 17A-17B are colored photographs of a 52-year old woman that underwent a vacuum treatment, in accordance with the present invention. FIGS. 17A was taken prior to the treatment and FIG. 17B was taken after two months of treatment. The treatment schedule was as in FIGS. 16A-16B, hereinabove.

As seen when comparing FIGS. 17B and 17A, there is a marked improvement in facial tone, after two months of treatment.

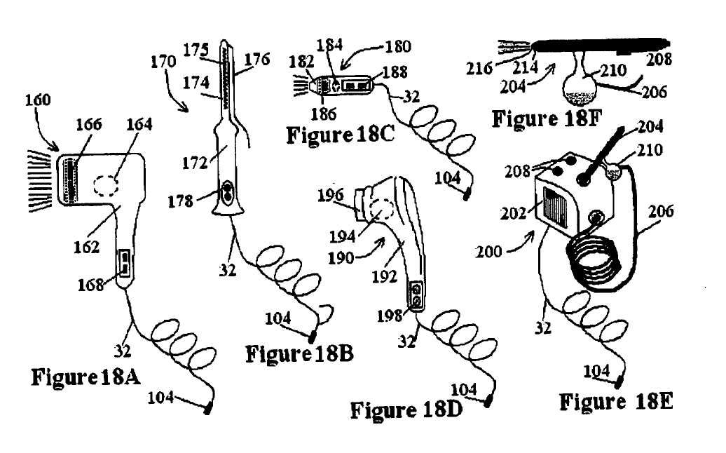

Referring further to the drawings, FIGS. 18A-18F schematically illustrate a plurality of devices for face, body and hair treatments, which may be included with system 100 (FIG. 14), in accordance with preferred embodiments of the present invention. The plurality of devices for face, body and hair treatments may selectively connect lo power-and-control outlet 74, of power-and-control console 70, for example, via a coaxial plug 104, for power and signals. In accordance with the present invention, the plurality of devices for face, body and hair treatments may include, for example:

1. A hair blower 160 (FIG. 18A), which may include a body 162, a motor 164, and preferably also, at least one heating element 166 and one, and possibly two or more control switches 168, for example, for controlling the air flow rate and temperature. Preferably air flow rates are between 50 and 500 liters per minute, and preferably, between one and three levels of heating powers are provided, for example, 400 watts, 800 watts, and 1200 watts, or only 800 and 1200 watts, or only 800 watts. for example, by using between one and three heating elements 166, each of 400 watts. Alternatively, a combination of heating elements 166 of 300 or 200 watts may be used. It will be appreciated that other values may similarly be use. Hair blower 160 is adapted to selectively connect to power-and-control console 70 (FIG. 14), via power-and-control line 32 and plug 104. It will be appreciated that hairblower 160 may come with no heating elements 166. It will be appreciated that cooling diodes, for example as taught in conjunction with FIG. 7, may be used with hairblower 160, in place of, or in addition to heating elements 166.

In accordance with another preferred embodiment of the present invention, hair blower 160 may be shaped as a bat that is worn over the head. Again, one, and possibly two or more control switches, for example, for controlling the air flow rate and temperature, may be provided.

2. A hair curler 170 (FIG. 18B), which may include a handle 172, heating element 174, a hair gripping element 176, and one, and possibly two or more control switches 178, for example, an on/off switch and a temperature control switch. Hair curler 170 includes one and preferably several heating elements 175, for example of 200 or 400 watts each, thus providing the temperature control, via control switches 178. It will be appreciated that other values may similarly be use. Hair curler 170 is adapted to selectively connect to power-and-control console 70 (FIG. 14), via power-and-control line 32 and plug 104.

3. A nail dryer 180 (FIG. 18C), which may include a body 182, a motor 184, preferably also, at least one heating element 186 and one, and possibly two or more control switches 188, for example, for controlling the air flow rate and temperature. Preferably the air flow rate is between 50 and 500 liters per minute, and preferably one heating element 186 of 400 watts is used. Alternatively, two or more heating elements 186 may be used. However, it will be appreciated that other values may similarly be use. Nail dryer 180 is adapted to selectively connect to power-and-control console 70 (FIG. 14), via power-and control line 32 and plug 104. It will be appreciated that nail dryer 180 may come with no heating element 186. It will be appreciated that cooling diodes, for example as taught in conjunction with FIG. 7, may be used with nail dryer 180, in place of, or in addition to heating element 186.

4. a face-and-body-cleaning-moisturizing-and-massaging device 190 (FIG. 18D), which may be fashioned, for example, as the Deman™, described in www.demanew.com, as downloaded on Apr. 9, 2003, or a similar device for cleaning and massaging of the face and (or) the body, as known. Face and body cleaning, moisturizing, and massaging device 190 may include a body 192, a preferably replaceable sponge 194, a motor 196, for producing the vibrating motion, and one, and possibly two or more control switches 198, for example, an on/off switch and a vibration speed switch. Face and body cleaning, moisturizing, and massaging device 190 may be provided with various creams and lotions (not shown) for cleaning, moisturizing, and (or) nourisking the skin. The creams aid lotions may include micro-crystals, for intensive cleaning of the skin. Face and body clearing, moisturizing, and massaging device 190 is adapted to selectively connect to power-and-control console 70 (FIG. 14), via power-and-control line 32 and plug 104.

5. an airbrush system 200 (FIGS. 18E-18F), which may be fashioned, for example, as any one of the DINAIR® systems, described in www.dinair.comy as downloaded on Apr. 9, 2003, or a similar system, as known. Airbrush system 200 may include a compressor unit 202, for housing a compressor, an airbrush 204, a dye canister 210, preferably mounted on airbrush 204, and an air hose 206, for providing commnunication between compressor unit 202 and airbrush 204, via dye canister 210. Preferably, dye canister 210 may be selectively removed from airbrush 204, for filling. Alternatively, dye canister 210 may be housed within compressor unit 202, next to the compressor. Airbrush 204 includes an air spout 214, with an opening 216. One, and possibly two or more control switches; 208, which may be located on compressor unit 202 or on airbrush 204, may include a first control switch for controlling the air flow rate, and a second control switch for controlling the size of opening 216. Preferably the air flow rate is 500 liters per minute, but rates between 50 and 500 may be used. However, it will be appreciated that other values may similarly be use.

Preferably, airbrush system 200 may be used for eye makeup, facial makeup, body painting, tanning, tattoo-like applications, nail drawings, hair dying, and other color applications to the face and body, as known. Furthermore, airbrush system 200 may be a professional system, used, for example, in TV and movie studios, or a home system. Airbrush system 200 may he provided with a plurality of air spouts 214, for controlling the spray imprint Airbrush system 200 is adapted to selectively connect to power-and-control console 70 (FIG. 14), via power-and-control line 32 and plug 104.

It will be appreciated that any of the devices and systems described hereinabove, in conjunction with FIGS. 18A-18F, may come with no control switch, and their operation will be controlled by the insertion of their plug 104 into receptor 102 (FIG. 14).

It will be appreciated that other devices for face, body and hair treatments may similarly be included with system 100, for receiving power from system 100, for example, other massage systems, or other erection implements.

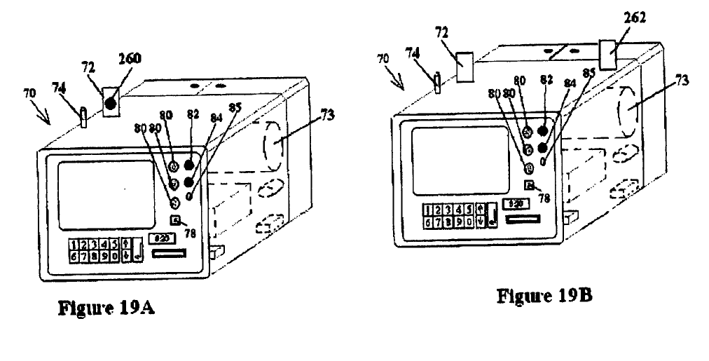

Referring further to the drawings, FIGS. 19A-19B schematically illustrate power-and-control console 70, in accordance with other preferred embodiments of the present invention. In FIG. 19A, a switch 260 is provided for selectively converting vacuum source 73 to a compressor 73. Vacuum outlet 72 then becomes air outlet 72.

Alternatively, as seen in FIG. 19B, an exhaust 262 of vacuum source 73 may be used as an air outlet 262.

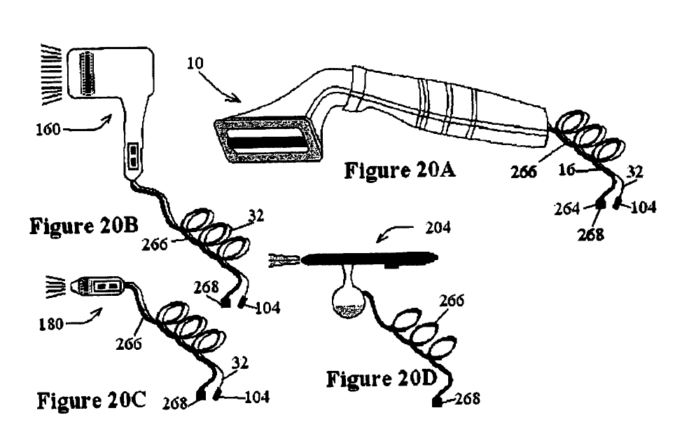

Referring further to the drawings, FIGS. 20A-20D schematically illustrate a plurality of devices for face, body and hair treatments, which may be included with system 100 (FIG. 14), and may selectively connect to power-and-control console 70.

As seen in FIG. 20A, device 10 is adapted to selectively connect to power-and-control outlet 74, for example, via power-and-control line 32 and preferably coaxial plug 104, and adapted to connect to vacuum outlet 72, via vacuum hose 16 and vacuum connector 264.

Alternatively, in accordance with the present embodiment, vacuum line 16 may double as airline 266, with air connector 268, for receiving air from air outlet 262 (FIG. 19B). Thus device 10 may operate as a dryer or an air blower, for example as a nail dryer or a hair blower. Various heating elements, for example, heating diodes, may be used with device 10, when operating as an air blower, for example, for drying.

As seen in FIG. 20B, hair blower 160 need not include motor 164 (FIG. 18A). Rather, it is adapted to selectively connect to air outlet 72 (FIG. 19A) or air outlet 262 (FIG. 19B), via airline 266 and air connector 268. Additionally, hair blower 160 is adapted to selectively connect to power-and-control outlet 74, for example, via power-and-control line 32 and coaxial plug 104.

As seen in FIG. 20C, nail dryer 180 need not include motor 184 (FIG. 18C). Rather, it is adapted to selectively connect to air outlet 72 (FIG. 19A) or air outlet 262 (FIG. 19B), via airline 266 and air connector 268. Additionally, nail dryer 180 is adapted to selectively connect to power-and-control outlet 74, for example, via power-and-control line 32 and coaxial plug 104.

As seen in FIG. 20D, airbrush 204 is adapted to selectively connect to air outlet 72 (FIG. 19A) or air outlet 262 (FIG. 19B), via airline 266 and air connector 268.

It will be appreciated that other devices and systems may be connected to any one of power-and-control outlet 74, vacuum outlet 72 and air outlet 72 (FIG. 19A) or air outlet 262 (FIG. 19B). It will be further appreciated that in accordance with the embodiments of FIGS. 19A and 19B, vacuum outlets 72 or 262 and air outlet 72 may not he used simultaneously.

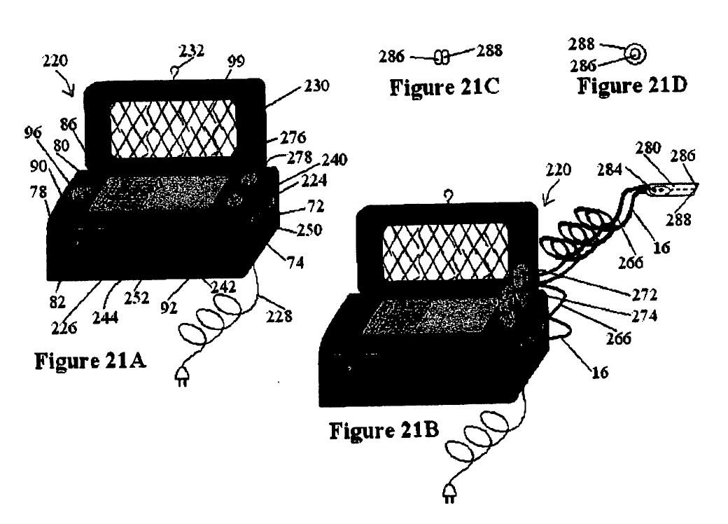

Referring further to the drawings, FIGS. 21A-21D schematically illustrate system 220 in accordance with another preferred embodiment of the present invention.

As seen in FIG. 21A, system 220 may be arranged as a laptop, preferably, with a storage compartment, for example, as a 3-layer suitcase.

A first layer 230 may be operative as a cover, and preferably include mirror 99.

A second layer 240 may be operative as power-and-control console 70, generally as described hereinabove in conjunction with FIG. 13A, and may be further adapted to latch with first layer 230, via a complimentary latch system formed of latch elements 232 of layer 230 and 242 of layer 240.

A third layer 250 may be operative as a storage box, for example, to any of the devices, spouts, and systems described hereinabove, in conjunction with FIG. 1A-12 and 18A-18F. Third layer 250 may be adapted to latch with second layer 240, via a complimentary latch system, formed of latch elements 244 of layer 240 and 252 of layer 250.

A carrying handle 226 may also be provided. A power line 228 connects system 220 to the grid.

Preferably, power-and-control console 70, of second layer 240, provides vacuum to vacuum hose 16 (FIG. 1A), via vacuum outlet 72, and power to power-and-control line 32 (FIG. 1A, 18A-18E), via power-aid-control outlet 74. Additionally, power-and-control console 70 preferably includes on/off control knob 78, light indicator 82, clock 96, and interactive display panel 86, which may display various buttons 80 and the feature or schedule that is selected.

Read/write storage system 90 such as a diskette drive, a CD drive, or a mini CD drive may be used for storing or reading specific schedules.

Preferably, the length of system 220 is between about 20 and about 60 cm, the width is between about 20 and about 40 cm, and the height is between about 15 and about 25 cm. The weight of system 220 may be between about 0.5 Kg. and about 7 Kg. It will be appreciated that other dimensions and weights, which may be larger or smaller, are also possible and are within the scope of the present invention.

In accordance with the present embodiment, power-and-control console 70 may include a compressor 202 (FIG. 18E), in addition to vacuum source 73 (FIG. 13A). Thus, vacuum outlet 72 and air outlet 224 may be operative simultaneously.

It will be appreciated that the devices of FIGS. 20A-20D it may be selectively connected to any one of, vacuum outlet 72, air outlet 224, and power-and-control outlet 74.

As seen in FIG. 21B, system 220 may be used also for face and body sandblasting, which is a form of cleansing, by using vacuum outlet 72 and air outlet 224 simultaneously.

Accordingly, a first jar 272 of clean crystals is mounted on a depression 276 (FIG. 21A), while a second, empty jar 274, adapted to receive the used crystals, is mounted on a depression 278.

Air line 266, flowing through first jar 272 carries the clean crystals to an outlet nozzle 286 of a sandblasting spout 280, while vacuum hose 16, which enters and exits second jar 274 sucks skin debris and crystals via inlet nozzle 288 of sandblasting spout 280.

It will be appreciated that during sandblasting, vacuum outlet 72 and air outlet 224 operate simultaneously.

FIG. 21C illustrates a first arrangement of outlet nozzle 286 and inlet nozzle 288, wherein the two nozzles are side by side.

FIG. 21D illustrates a second arrangement of outlet nozzle 286 and inlet nozzle 288, wherein the two nozzles are concentric.

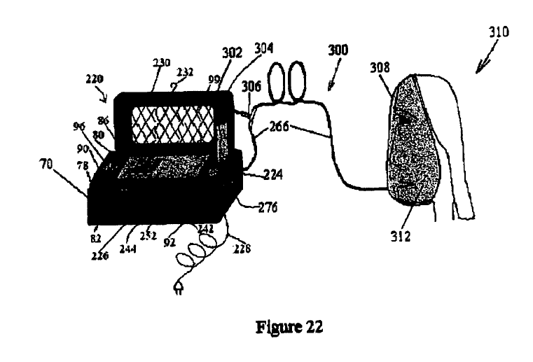

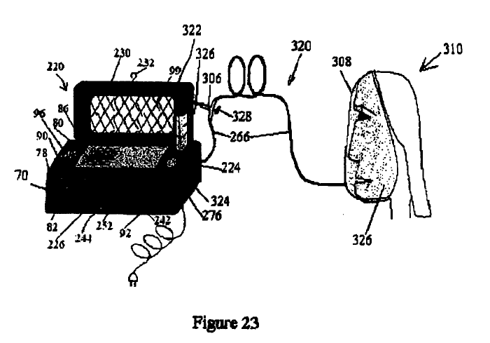

Referring further to the drawings, FIG. 22 schematically illustrates an oxygen therapy device 300 in accordance with a preferred embodiment of the present invention. Oxygen therapy device 300 preferably includes an oxygen canister 302, which includes liquefied oxygen, preferably mixed with an aromatic oil, which serves as a carrier, for penetrating the tissue and living cells.

In essence, the oxygen molecule may not penetrate a living cell, but when bound to a carrier, such penetration is facilitated. Oils that may be used as carriers are, for example, grape seed oil, safflower oil, or sweet almond oil. Additionally or alternatively, other oils or a combination of oils may be used.

Canister 302 may be arranged, for example, in depression 276. Preferably, canister 302 contains sufficient oxygen for a single treatment of about 15 minutes, at an oxygen concentration of between about 80% and about 90%, in the air.

A valve 304, mounted on canister 302, may be used to control the flow of oxygen and aromatic oil from the canister. Additionally, a connector 306 may be used to introduce the oxygen and aromatic oil to airline 266, which receives air from air outlet 224.

A mask 308 is provided, which a user 310 may place on his or her face, for receiving oxygen enriched air. The oxygen is breathed in, and may also penetrate facial tissue directly.

Preferably, canister 302 is adapted to provide about 15 minutes of oxygen enriched air, at a concentration of between 20 and 99 percent oxygen, preferably, between 80 and 95 percent. It will be appreciated that other values may be used. The aromatic oils may further be selected for their other properties for example, cell renewal, GI track infection suppression, pain relief, mood enhancer, and the like.

In accordance with the present invention, an oil, a cream, or an aromatic oil may be applied to the face, prior to applying mask 308, in addition to, or in place of the aromatic oil of canister 302. The oil, cream, or aromatic oil may be, for example, Johnson's Baby oil, another oil, facial cream, or aromatic oil, as known. Again, the aromatic oils may further be selected for their other properties for example, cell renewal, GI track infection suppression, pain relief, mood enhancer, and the like.

Alternatively a spout 12, for example, as taught in conjunction with FIG. 2A, hereinabove, may be used for oxygen therapy, in place of mask 308.

In accordance with the present invention, oxygen therapy may be used for cell renewal, improved metabolism, and body cleansing.

Alternatively, device 300 may be an ozone therapy device 300, and canister 302 may contain liquefied ozone.

Referring further to the drawings, FIG. 23 schematically illustrates a steam therapy device 320 in accordance with a preferred embodiment of the present invention. Steam therapy device 320 preferably includes a boiling unit 322, having a heater 324. Steam therapy device 320 may be arranged in depression 276, which includes a heater 324, for producing steam 326.

Steam, and possibly also mist, may flow from boiling unit 322 and join airline 266, via connector 306. A valve 328 may be used to regulate the mixture of steam and mist on one hand, and air, on the other. Preferably, airline 266 receives air from air outlet 224.

User 310 may thus place mask 308 over his or her face and breath air, which is highly enriched with steam or mist 326. Steam system 320 may be used, for example, when user 310 has a cold, or in advance of facial cleansing or in advance of an application of certain creams, since the steam is operative to open facial pores.

Alternatively a spout 12, for example, as taught in conjunction with FIG. 2A, hereinabove, may be used for steam therapy, in place of mask 308.

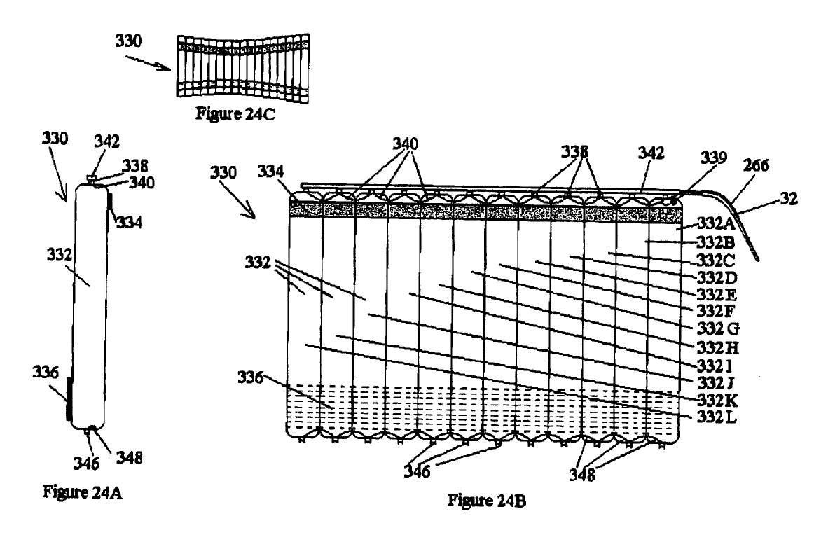

Referring further to the drawings, FIGS. 24A-24C schematically illustrate side and front views of a for lymphatic massage device 330, in accordance with a preferred embodiment of the present invention. The purpose of lymphatic massage device 330 is to provide a low-power, gentle massage that reduces the concentration of interstitial fluids in the tissue.

Preferably, lymphatic massage device 330 includes a series of pockets 332, such as 332A-332L, each having a solenoid valve 33S, in communication with airline 266. Preferably, gentle massage is provided, by cyclic inflation of the pockets, one after the other, so that each, in turn, provides pressure, for example, on a limb, such as an arm or a leg, generating a gentle pressure wave on the limb. Alternatively, lymphatic massage device 330 may be used on the belly. During operation, solenoid valve 338 of pocket 332A opens first, filling up pocket 332A to provide pressure onto the limb. The solenoid valve of pocket 332A then closes, but that of pocket 332B opens up, and while the pressure from pocket 332A is reduced, via opening 346, that from pocket 332B is builds up.

A power-aid-signal-cable 340 provides power and communication between solenoid valves 338 and power-and-control console 70 of system 20 (FIGS. 22 or 23), via power-and-control cable 32. A pressure sensor 339, in communication with power and signal cable 340, may be used, in at least one pocket 332, for determining the extent of inflation. One sensor 339 may be sufficient, where the pockets are similar in size and construction. It will be appreciated that more than one sensor 339 may be used.

Additionally, a second series of openings 346 is provided. Solenoid valves and a power and signal cable 348 may be provided for them Alternatively, these are mere openings, for example, of 2-5 mm in diameter. It will be appreciated eat other values may similarly be used. Openings 346 need not have valves because generally the rate of inflow will be much greater than the rate of outflow.

Preferably, peak absolute pressure for each pocket may be set at between 1.5 and 2.0 atmospheres, for example, 1.8 atmospheres, at sea level, based on the reading of pressure sensor 339.

Velcro strips 334 and 336 are used for wrapping lymphatic massage device 330 around a limb, such as an arm, an ankle, or a leg. Lymphatic massage system 330 may extend through a portion of tile limb or the whole limb.

It will be appreciated that pockets 332 need not be identical. Rather, they may be constructed so as to accommodate the geometry of a specific limb. For example, FIG. 24C illustrates lymphatic massage device 330 designed for a leg, from the ankle to the thigh. Where pockets 332 are not identical, pressure sensors 339 may be used in each pocket.

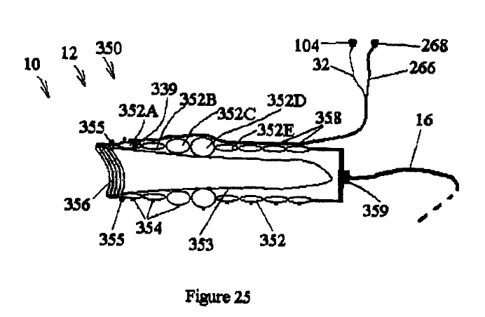

Referring further to the drawings, FIG. 25 illustrates an erection massage device 350, in accordance with a preferred embodiment of the present invention. To some extent, erection massage device 350 is similar to erection implement 150, described hereinabove, in conjunction with FIG. 12, but erection massage device 350 includes a massage system, similar to that of lymphatic massage device 330 of FIGS. 24A-24C.

Accordingly, erection massage device 350 includes a soft, flexible hose 352, having a plurality of pockets, such as 325A, 325B, 325C, 325D, and 325E. Flexible hose 352 connects to vacuum hose 16, via a connector 319. Additionally, flexible hose 352 includes a mouthpiece 356, adapted to form a seal with the body. Preferably, mouthpiece 356 is soft and flexible, formed for example, as an accordion, so as to adapt to the body shape.

In order to prevent fluids from reaching vacuum hose 16, a condom 353 may be used, inserted into erection implement 350, folded over the edges of mouthpiece 356, and held, for example, with a rubber band 355.

Airline 266, and power-and-control cable 32, in communication with pockets 325A, 3251. 325C, 325D, and 325E, via solenoid valves 354 provide a gentle massage, by cyclic inflation of the pockets, one after the other, so as provide a gentle pressure wave on the penis. Preferably, peak absolute pressure for each pocket may be set at between 1.5 and 2.0 atmospheres, for example, 1.8 atmospheres, at sea level, based on the readings of pressure sensor 339, of which, at least one, and possiblly several may be used.

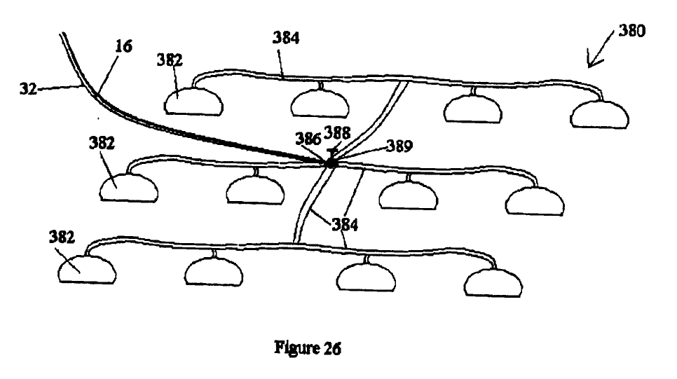

Referring further to the drawings, FIG. 26 schematically illustrate a cupping device 380, in accordance with a preferred embodiment of the present invention.

Cupping device 380 includes a plurality of cups 382, connected by a network of vacuum hoses 384, which come together at a junction 386, and connect with vacuum hose 16 and power-and-control cable 32. Junction 386 may further include a valve 388, preferably a solenoid valve, which may further include a pressure sensor 389, for controlling the vacuum in airlines 384. Alternatively, each cup 32 may be directly connected to vacuum hose 16, and to power-and-control cable 32 and may possibly include a valve and possibly also a pressure sensor.

Cupping device 380 is preferably intended for the treatment of mascular-skeletal pain, for example, by placing plurality of cups 382 on the back of a user (not shown). It is generally believed that the application of a mild vacuum, for example, −50 to −500 bars, by cups, causes an enlargement of the peripheral blood capillaries, and leads to relief of mascular-skeletal pain. Thus plurality of cups 382 is adapted for the application of a mild vacuum, for example, −50 to −500 bars. It will be appreciated that other values are also possible.

In accordance with the present invention, cups 382 may further include any one of the features described hereinabove, in connection with FIGS. 3A-8, such as an infrared light treatment, UV light treatment, LLLT, or electrostimulation therapy.

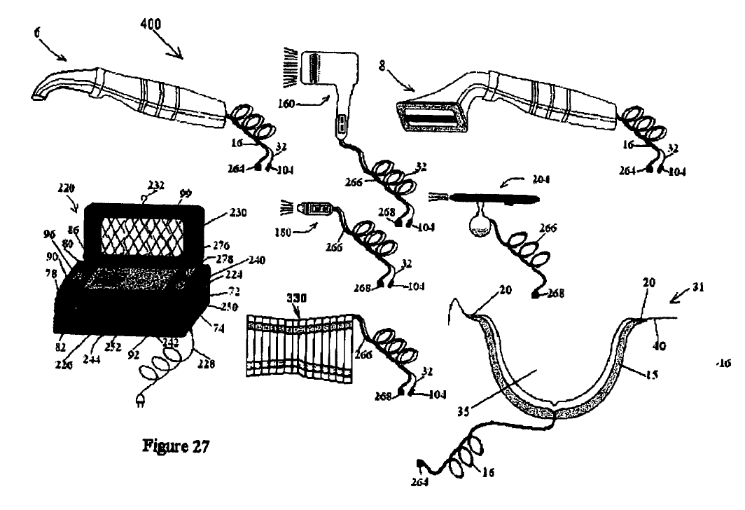

Referring further to the drawings, FIG. 27 schematically illustrates a face-and-body-treatment system 400 for home use of the woman. System 400 may include any one of, and preferably a plurality of the devices taught in conjunction with the drawings hereinabove, preferably excluding the erection implements of FIGS. 12 and 25. Preferably face-and-body-treatment system 400 for home use of the woman is designed and colored in a manner that is likely to appeal to women. Face-and-body-treatment system 400 for home use of the woman may be use by the general female community, as well as by women of the performing arts.

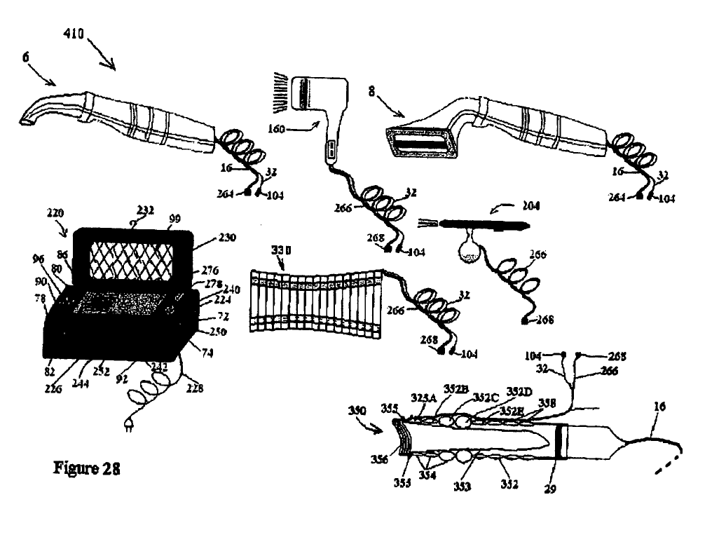

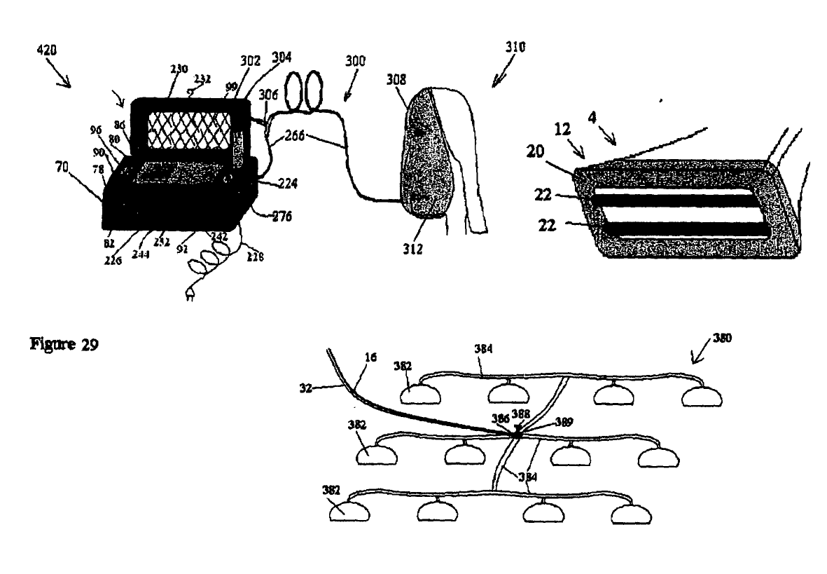

Referring further to the drawings, FIG. 28 schematically illustrates a face-and-body-treatment system 410 for home use of the man. System 410 may include any one of, and preferably a plurality of the devices taught in conjunction with the drawings hereinabove, preferably excluding the breast firming device of FIGS. 2D-2F. Preferably face-and-body-treatment system 410 for home use of the man is designed and colored in a manner that is likely to appeal to men. Face-and-body-treatment system 410 for home use of the man is designed for the general male community, people of the performing arts, the homosexual community and drug queens, and may be colored and authentically designed specifically for each community.

Referring further to the drawings, FIG. 29 schematically illustrates a face-and-body-treatment system 420 for clinics. A clinic version may include any one of, and preferably a plurality of the devices taught in conjunction with the drawings hereinabove, preferably including devices that require assistance for their application, for example, cupping device 380 or double-roller rectangular spout 4 for applying suction massage therapy to the body, in addition the other devices taught in conjunction with the drawings hereinabove.

It will be appreciated that the face and body systems of the present invention nay be divided to:

a first-generation system, which includes a suction pump, and which is described in conjunction with FIGS. 1A-18F and FIG. 26:

a second-generation system, which includes a suction and air-blowing pump, and which is described in conjunction with FIGS. 19A-20D and

a third-generation system, which includes a pump and a compressor, for suction and for air blowing, for example, as described in conjunction with FIGS. 21A-21B.

It will be appreciated that the systems, which are described in conjunction with FIGS. 22-25, and 27-29 may be second or third generation systems.

It will be appreciated that an oil or a cream, which may be for example, a baby oil, a body lotion, a hand cream, a facial cream, a facial tonic, a collagen cream, an aromatic oil, or an aromatic cream may be used together the system of the present invention. Some oils and (or) creams, which may be used in conjunction with the present inventions are olive oil, jojoba oil, shea butter, avocado oil, peach-kernel oil, pumpkin-seed oil, Saint Johns Wort oil, safflower oil, almond oil, grape-seed oil, and other oils and combinations of oils as known.

In accordance with another pref rred embodiment of the present invention, the user may buy a system of the present invention with a limited number of attachments. Additionally, the user may upgrade his system by buying additional attachments at a later time.

It will be appreciated that power-and-control line 32 may be replaced by dedicated power and control lines, each with an individual plug, replacing coaxial plug 104. It will be appreciated that other connectors as known may be used, in place of coaxial plug 104.

It is appreciated that certain features of the invention, which are, or clarity, described in the context of separate embodiments, may also be provided in combination in a single embodiment. Conversely, various features of the invention which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification to the same extent as if each individual publication patent or patent application was specifically and individually indicated to be incorporated herein by reference. In addition, citation or identification of any reference in this application shall not be construed as an admission that such reference is available as prior art to the present invention.

1-82. (Canceled)

83. A face-and-body-treatment system, adapted for self application, comprising:
a computerized device, which comprises at least one control feature;
at least one electronically controlled treatment device, in signal communication with said computerized device; for control by said computerized device, said treatment device being adapted to apply at least one mode of treatment, selected from the group consisting of a suction treatment, a suction-and-roller macro-massage treatment, a warming light treatment, an infrared light treatment, a visible light treatment, a UV light treatment, an low level laser treatment (LLLT), an ultrasound treatment, a pulsating magnetic field treatment, a constant magnetic field treatment, an electrostimulation treatment, a cooling-diode treatment, a warming-diode treatment, a cooling-warming-diode treatment, a photoepilation, and a mechanical epilation, a cupping treatment, hair drying, nail drying, hair curling, skin cleansing-moisturizing-massaging treatment, sandblasting-peeling treatment, airbrush makeup application, oxygen treatment, ozone treatment, steam treatment, and lymphatic massage treatment; and
a mirror, integrated with said system, for viewing a self-application of a treatment.

84. The system of claim 83, comprising a control panel, on which said at least one control feature is mounted.

85. The system of claim 84, wherein said control panel comprises a display screen, for displaying parameters relating to said treatment.

86. The system of claim 84, wherein said control panel comprises a timing device.

87. The system of claim 84, wherein said mirror is integrated with said control panel.

88. The system of claim 83, adapted for storing desired operational schedules in a memory.

89. The system of claim 83, adapted for automatically applying desired operational schedules stored in a memory.

90. The system of claim 83, wherein said at least one electronically controlled treatment device comprises at least two electronically controlled treatment devices, of different features.

91. The system of claim 83, wherein said system is adapted to receive a plurality of detachable and interchangeable electronically controlled treatment devices.

92. The system of claim 83, wherein said at least one electronically controlled treatment device is adapted for applying at least two modes of treatment.

93. The system of claim 92, wherein said at least two modes of treatment may be automatically applied in accordance with a predetermined automatic schedule, selected from the group consisting of a single-mode application, an application of different modes in parallel, and an application of different modes in series.

94. The system of claim 83, comprising a storage compartment.

95. The system of claim 94, wherein said storage compartment is adapted for storing accessories.

96. The system of claim 94, wherein said storage compartment is adapted for storing treatment creams and oils.

97. The system of claim 83, arranged as a laptop and enclosed in a carrying case.

98. An electronically controlled treatment device, comprising:
a spout, which defines an inner chamber, and which is in communication with a vacuum source, for applying a suction treatment to a portion of a body of a user; and
at least one ultrasound transducer, integrated with said spout, for applying an ultrasound treatment to said portion of said body.

99. The device of claim 98, in signal communication with a control unit, for automatic application of said suction and ultrasound treatments, in accordance with a schedule selected from the group consisted of application in tandem and application in series.

100. The electronically controlled treatment device of claim 98, adapted for treating cellulite.

101. The electronically controlled treatment device of claim 98, wherein said spout comprises a roller, and said spout is adapted to glide along said portion of said body and apply a suction-and-roller macro-massage treatment thereto.

102. The electronically controlled treatment device of claim 98, wherein said spout is adapted to apply an additional mode of treatment, selected from the group consisting of a warming light treatment, an infrared light treatment, a visible light treatment, a UV light treatment, an low level laser treatment (LLLT), an ultrasound treatment, a pulsating magnetic field treatment, a constant magnetic field treatment, an electrostimulation treatment, a cooling-diode treatment, a warming-diode treatment, a cooling-warming-diode treatment, a photoepilation, and a mechanical epilation, wherein said suction treatment, said ultrasound treatment, and said additional mode of treatment may be selectively applied in tandem and selectively applied in sequence, in accordance with predetermined restrictions.

103. An electronically controlled treatment device, comprising:
a spout, which defines an inner chamber, and which is in communication with a vacuum source, for applying a suction treatment to a portion of a body of a user; and
an electromagnet, integrated with said spout, for applying a pulsating magnetic field treatment to said portion of said body.

104. The device of claim 103, in signal communication with a control unit, for automatic application of said suction and pulsating magnetic field treatments, in accordance with a schedule selected from the group consisted of application in tandem and application in series.

105. The electronically controlled treatment device of claim 103, wherein said spout comprises a roller, and said spout is adapted to glide along said portion of said body and apply a suction-and-roller macro-massage treatment thereto.

106. The electronically controlled treatment device of claim 103, wherein said spout is adapted to apply an additional mode of treatment, selected from the group consisting of a warming light treatment, an infrared light treatment, a visible light treatment, a UV light treatment, an low level laser treatment (LLLT), an ultrasound treatment, a pulsating magnetic field treatment, a constant magnetic field treatment, an electrostimulation treatment, a cooling-diode treatment, a warming-diode treatment, a cooling-warming-diode treatment, a photoepilation, and a mechanical epilation, wherein said suction treatment, said pulsating magnetic field treatment, and said additional mode of treatment may be selectively applied in tandem and selectively applied in sequence, in accordance with predetermined restrictions.

107. A face-and-body-treatment system, adapted for self application and comprising:
a computerized device, which comprises at least one control feature;
a vacuum pump, in signal communication with said computerized device, for control by said computerized device;
a compressor, in signal communication with said computerized device, for control by said computerized device;
a sandblasting peeling device, operative with a container of micro crystals, and comprising:
a blow channel, in fluid communication with said compressor and further in communication with said container of micro crystals, for sandblasting a tissue with micro crystals; and
a suction channel, in fluid communication with said pump, for sucking up used microcrystals and tissue debris;
at least one electronically controlled treatment device, in signal communication with said computerized device; for control by said computerized device, and in fluid communication with said vacuum pump, for applying a suction treatment.

108. A face-and-body-treatment system, adapted for self application and comprising:
a computerized device, which comprises at least one control feature;
a vacuum pump, in signal communication with said computerized device, for control by said computerized device;
a compressor, in signal communication with said computerized device, for control by said computerized device;
a sandblasting peeling device, operative with a container of microcrystals, and comprising:
a blow channel, in fluid communication with said compressor and further in communication with said container of microcrystals, for sandblasting a tissue with microcrystals; and
a suction channel, in fluid communication with said pump, for sucking up used microcrystals and tissue debris;
at least one electronically controlled treatment device, in signal communication with said computerized device; for control by said computerized device, and in fluid communication with said compressor, for applying a treatment selected from the group consisting of hair drying, nail drying, and oxygen treatment.

109. An oxygen treatment device, comprising:
a canister which includes
liquefied oxygen; and
a carrying substance, for enabling said oxygen to be absorbed by a tissue.

110. The oxygen treatment system of claim 109, further comprising a regulating valve, to control the outflow of said oxygen.

111. The oxygen treatment system of claim 109, further comprising a regulating gauge, to monitor the outflow of oxygen.

112. The oxygen treatment system of claim 109, further comprising a connector, for connecting to an air line.

113. The oxygen treatment system of claim 109, further comprising a connector, for connecting to an applicator.

114. The oxygen treatment system of claim 113, wherein said applicator is a face mask.

115. The oxygen treatment system of claim 113, wherein said applicator is an inhaler.

116. The oxygen treatment system of claim 109, sized for a single oxygen treatment of substantially 15 minutes.

117. The oxygen treatment device of claim 109, wherein said carrier is an aromatic oil.

118. An oxygen treatment device, comprising:
a canister which includes:
pressurized oxygen; and
a carrying substance, for enabling said oxygen to be absorbed by a tissue.

119. The oxygen treatment system of claim 118, wherein said pressurized oxygen is provided in the form of liquefied oxygen.

120. The oxygen treatment system of claim 118, comprising a regulating valve, to control the outflow of said oxygen.

121. The oxygen treatment system of claim 118, comprising a regulating gauge, to monitor the outflow of oxygen.

122. The oxygen treatment system of claim 118, comprising a connector, for connecting to an air line.

123. The oxygen treatment system of claim 118, comprising a connector, for connecting to an applicator.

124. The oxygen treatment system of claim 123, wherein said applicator is a face mask.

125. The oxygen treatment system of claim 123, wherein said applicator is an inhaler.

126. The oxygen treatment system of claim 118, sized for an oxygen treatment of between about 5 and about 30 minutes.

127. The oxygen treatment device of claim 118, wherein said carrier is an aromatic oil.

128. A method of providing an oxygen treatment to a tissue, comprising:
providing an oxygen applicator, which defines a volume, said volume being in communication with said tissue;
providing gaseous oxygen, from a single-use oxygen canister of pressurized oxygen, in communication with said volume; and
providing to said volume, a carrying substance, for enabling said gaseous oxygen to be absorbed by said tissue.

129. The method of claim 128, wherein said applicator is a face mask.
